(19) United States
(12) Patent Application Publication
(10) Pub. No.: US 2015/0156196 A1
(43) Pub. Date: Jun. 4, 2015

(54) WEARABLE ELECTRONIC DEVICE AND METHOD FOR CONTROLLING SAME

(71) Applicant: INTELLECTUAL DISCOVERY CO., LTD., Seoul (KR)

(72) Inventors: Jun Sik Kim, Daejeon (KR); Seung Mo Jung, Seoul (KR)

(73) Assignee: INTELLECTUAL DISCOVERY CO., LTD., Seoul (KR)

(21) Appl. No.: 14/413,802

(22) PCT Filed: Jul. 30, 2013
(86) PCT No.: PCT/KR2013/006821

§ 371 Date: Jan. 9, 2015

(30) Foreign Application Priority Data
Jul. 31, 2012 (KR) 10-2012-0083809
Jul. 31, 2012 (KR) 10-2012-0083810

(51) Int. Cl. H04L 29/06; G02B 27/01

(52) U.S. Cl. CPC H04L 63/0861; G02B 27/017; G02B 2027/0178

(57) ABSTRACT

The present invention relates to a wearable electronic device and to a method for controlling same, wherein the device includes: at least one lens; a display device allowing information to be displayed on the lens; a sensing unit obtaining bio-information of a user; and a control unit performing user authentication by using the obtained user bio-information to control functions of the wearable electronic device according to the user authentication result.

### TECHNICAL FIELD

The present invention relates to a method of controlling a wearable electronic device in a type of glasses and the like.

### BACKGROUND ART

An augmented reality technology displays, for users, a real world supplemented by overlapping a virtual object and the real world. From this point of view, the augmented reality technology differs from a virtual reality technology and provides a further vivid reality to users compared to a virtual reality.

In general, an augmented reality technology enables a variety of information to be displayed before eyes of a user using a display device, for example, a head mounted display (HMD) or a head up display (HUD). In addition, research on manipulating an augmented object in an augmented reality using a gesture recognition is actively conducted.

The HMD is mounted to a head or other portions of a user and to display an independently projected image on each of left and right eyes. Accordingly, when a user observes an object of view carefully, different images are converged on both eyes and such a binocular disparity enables the user to have a perception of depth. In addition, the HUD projects an image onto a transparent glass such as glass and enables a user to visually recognize information and an external background projected onto the transparent glass from the HUD at the same time.

### DISCLOSURE OF INVENTION

### Technical Goals

The present invention provides a wearable electronic device capable of limiting a function based on user information.

The present invention also provides a wearable electronic device capable of readily recording and managing a life log of a user.

### Technical Solutions

According to an aspect of the present invention, there is provided a wearable electronic device provided with at least one lens and a display device configured to display information on the lens, the wearable electronic device including: a sensing unit configured to obtain user bio-information of the wearable electronic device; and a control unit configured to perform a user authentication based on the obtained user bio-information and to control a function of the wearable electronic device based on a result of the user authentication.

According to another aspect of the present invention, there is provided a wearable electronic device provided with at least one lens and a display device configured to display information on the lens, the wearable electronic device including: a camera configured to capture an image by performing photographing at predetermined intervals; a sensing unit configured to detect user bio-information and motion information of the wearable electronic device; and a control unit configured to synchronize the captured image with information detected by the sensing unit, and to control the synchronized image to be stored or transmitted.

### Effects of the Invention

According to embodiments of the present invention, it is possible to provide a user-based view restricted service or a customized service by performing a user authentication based on bio-information about a user of a wearable electronic device and by controlling a function of the wearable electronic device based on a result of the user authentication.

Also, according to embodiments of the present invention, since a wearable electronic device synchronizes an image captured at predetermined intervals with bio-information and motion information of a user and thereby stores or manages the synchronized image, it is possible to record and manage a life log of the user without perception of the user and to easily cope with a dangerous situation that the user encounters.

### BRIEF DESCRIPTION OF DRAWINGS

FIGS. 1 and 2 are perspective views illustrating a configuration of a wearable electronic device according to an embodiment of the present invention;

FIG. 3 illustrates an example of a view viewed by a user through a wearable electronic device;

FIGS. 4 and 5 are perspective views illustrating a configuration of a wearable electronic device according to another embodiment of the present invention;

FIG. 6 is a block diagram illustrating a configuration of a wearable electronic device according to an embodiment of the present invention;

FIG. 7 is a flowchart illustrating a controlling method according to an embodiment of the present invention;

FIGS. 8 and 9 are views illustrating a lateral configuration of a wearable electronic device according to an embodiment of the present invention;

FIGS. 10 and 11 are views illustrating a front configuration of a wearable electronic device according to an embodiment of the present invention;

FIG. 12 illustrates a screen displayed on a display device according to an embodiment of the present invention;

FIGS. 13 through 17 are views describing a method of controlling a function of a wearable electronic device based on a user authentication result according to a first embodiment of the present invention;

FIGS. 18 through 21 are views describing a method of controlling a function of a wearable electronic device based on a user authentication result according to a second embodiment of the present invention;

FIGS. 22 through 24 are views describing a method of controlling a function of a wearable electronic device based on an adult authentication result according to an embodiment of the present invention;

FIG. 25 is a view describing a method of controlling a function of a wearable electronic device based on a viewing time according to an embodiment of the present invention;

FIGS. 26 and 27 are views describing a method of limiting a use of a portable terminal based on user information according to an embodiment of the present invention;

FIGS. 26 and 27 are views describing a method of limiting a use of a portable terminal based on user information according to an embodiment of the present invention;

FIGS. 28 through 30 are views describing a method of limiting a use of a personal computer (PC) based on user information according to an embodiment of the present invention;

FIGS. 31 through 33 are views describing a user interface configured on a wearable electronic device according to an embodiment of the present invention;

FIG. 34 illustrates another example of a view viewed by a user through a wearable electronic device;

FIG. 35 is a block diagram illustrating a configuration of a wearable electronic device according to another embodiment of the present invention;

FIG. 36 is a flowchart illustrating a controlling method according to another embodiment of the present invention;

FIGS. 37 and 38 are views illustrating a lateral configuration of a wearable electronic device according to another embodiment of the present invention;

FIG. 39 is a block diagram illustrating a configuration of a user danger detection system according to an embodiment of the present invention;

FIGS. 40 and 41 are views illustrating a user interface for informing a take-off of a wearable electronic device according to an embodiment of the present invention;

FIGS. 42 through 46 are views illustrating a user interface for informing a state of a user based on a danger level of the user according to an embodiment of the present invention;

FIG. 47 is a view describing a method of setting a weight used to determine a danger level according to an embodiment of the present invention;

FIG. 48 is a view describing a method of providing a life log of a user together with map information according to an embodiment of the present invention; and

FIG. 49 is a view describing a method of representing a life log of a user according to an embodiment of the present invention.

### BEST MODE FOR CARRYING OUT THE INVENTION

Hereinafter, a wearable electronic device and a controlling method thereof according to an embodiment of the present invention will be described with reference to the accompanying drawings.

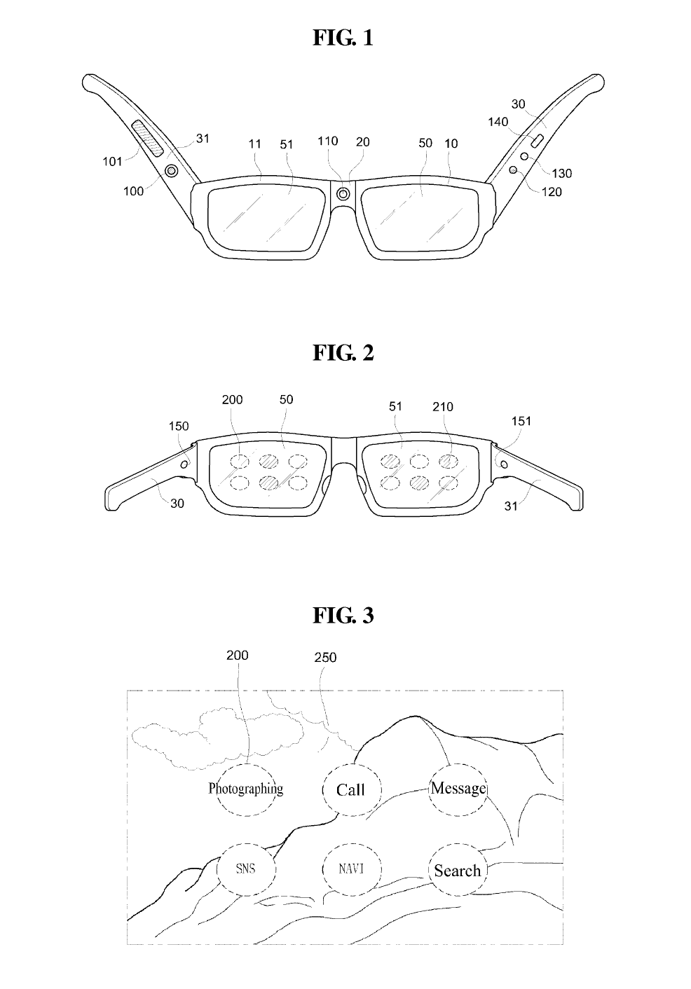

FIG. 1 is a perspective view illustrating a configuration of a wearable electronic device according to an embodiment of the present invention. Referring to FIG. 1, a wearable electronic device 1 may be manufactured in a type of glasses to be located to be proximate to eyes of a user.

FIG. 1 illustrates a shape of the wearable electronic device 1 viewed from a front. Referring to FIG. 1, the wearable electronic device 1 may include left and right lens frames 10 and 11, a frame connector 20, left and right side arms 30 and 31, and left and right lenses 50 and 51.

An image capturing device capable of taking a photo or a moving picture may be mounted on a front surface of the wearable electronic device 1. For example, as illustrated in FIG. 1, a camera 110 may be provided on a front surface of the frame connector 20.

Accordingly, while moving with wearing the wearable electronic device 1 in a type of glasses, a user may take a photo or a moving picture using the camera 110 and may store or share the taken photo or moving picture.

In this case, a view of an image taken by the camera 110 may be very similar to a view of a scene recognized at a sight of the user.

Also, a gesture such as a hand motion of the user is recognized using the camera 10. Thus, an operation or a function of the wearable electronic device 1 may be controlled in response to the recognized gesture.

A location of the camera 110 or the number of cameras 10 to be mounted may be changed. A special purpose camera such as an infrared ray (IR) camera may be used.

Also, units to perform a predetermined function may be disposed on each of the left and right side arms 30 and 31.

User interface devices for receiving a user input to control a function of the wearable electronic device 1 may be mounted on the right side arm 31.

For example, a track ball 100 or a touch pad 101 for selecting or moving an object such as a cursor and a menu on a screen may be mounted on the right side arm 31.

A user interface device provided to the wearable electronic device 1 is not limited the track ball 100 and the touch pad 101. A variety of input devices, such as a key pad, a dome switch, a jog wheel, and a jog switch, may be provided to the wearable electronic device 1.

Meanwhile, a microphone 120 may be mounted on the left side arm 30. An operation or a function of the wearable electronic device 1 may be controlled in response to a voice of the user recognized through the microphone 120.

Also, a sensing unit 130 is provided on the left side arm 30 and may detect a current state such as a location of the wearable electronic device 1, a presence/absence of a user contact, and acceleration/deceleration, or information associated with the user and may generate a sensing signal for controlling an operation of the wearable electronic device 1.

For example, the sensing unit 130 may include a motion sensor or a motion detector such as a gyroscope and an accelerometer, a location sensor such as a global positioning system (GPS) device, a magnetometer, and an orientation sensor such as a theodolite. However, the present invention is not limited thereto and may further include sensors capable of detecting a variety of information in addition to the sensors.

For example, the sensing unit 130 may further include an IR sensor. The IR sensor may include a light emitter configured to emit IR rays and a light receiver configured to receive the IR rays, and may be employed for IR communication or measuring a proximity.

The wearable electronic device 1 according to an embodiment of the present invention may include a communicator 140 for communication with an external device.

For example, the communicator 140 may include a broadcasting receiving module, a mobile communication module, a wireless Internet module, and a near field communication module.

The broadcasting receiving module receives a broadcasting signal and/or broadcasting related information from an outside broadcasting management server through a broadcasting channel. The broadcasting channel may include a satellite channel and a terrestrial channel. The broadcasting management server may refer to a server to generate and transmit a broadcasting signal and/or broadcasting related information, or a server to receive a broadcasting signal and/or broadcasting related information generated in advance and to transmit the broadcasting signal and/or broadcasting related information to a terminal. The broadcasting related information may indicate information associated with a broadcasting channel, a broadcasting program, or a broadcasting service provider. The broadcasting signal may include a television (TV) broadcasting signal, a radio broadcasting signal, and a data broadcasting signal, and may also include a broadcasting signal in which the data broadcasting signal is coupled with the TV broadcasting signal or the radio broadcasting signal.

Meanwhile, the broadcasting related information may be provided over a mobile communication network and in this example, may be received by a mobile communication module.

The broadcasting related information may be present in a variety of forms, for example, an electronic program guide (EPG) of a digital multimedia broadcasting (DMB) or an electronic service guide (ESG) of digital video broadcast-handheld (DVB-H).

The broadcasting receiving module may receive a digital broadcasting signal using a digital broadcasting system, for example, a digital multimedia broadcasting-terrestrial (DMB-T), a digital multimedia broadcasting-satellite (DMB-S), a media forward link only (MediaFLO), a DVB-H, and an integrated services digital broadcast-terrestrial (ISDB-T). The broadcasting receiving module may also be configured to be suitable for any type of broadcasting systems providing a broadcasting signal in addition to the aforementioned digital broadcasting system.

The broadcasting signal and/or the broadcasting related information received through the broadcasting receiving module may be stored in a memory.

Meanwhile, the mobile communication module transmits and receives a radio signal to and from at least one of a base station, an external terminal, and a server over a mobile communication network. The wireless signal may include a voice call signal, a video call signal, or various types of data according to transmission and reception of a text/multimedia message.

A wireless Internet module refers to a module for connection to the wireless Internet and may be provided inside or outside. A wireless Internet technology may use a wireless local area network (WLAN), a wireless fidelity (Wi-Fi), a wireless broadband (Wibro), a world interoperability for microwave access (WiMAX), and a high speed downlink packet access (HSDPA).

The near field communication module refers to a module for near field communication. A near field communication technology may use Bluetooth, radio frequency identification (RFID), infrared data association (IrDA), ultra wideband (UWB), and ZigBee.

Also, the wearable electronic device 1 according to an embodiment of the present invention may include a display device to transfer visual information to the user by displaying an image.

The display device may be configured to include a transparent unit or a light transmitting unit so that the user is capable of viewing information displayed on the display device and a front view displayed ahead the user.

For example, at least one of the left and right lenses 50 and 51 of FIG. 1 may function as the aforementioned transparent display whereby the user may visually recognize a text or an image formed on a lens and concurrently view a front view.

To this end, the wearable electronic device 1 enables a variety of information to be displayed ahead the user using the display device such as a head mounted device (HMD) or a head up device (HUD).

The HMD may include a lens configured to create a virtual image by magnifying an image and a display panel disposed at a relatively close location compared to a focal distance of the lens. When the HMD is mounted around a head of the user, the user may visually recognize the virtual image by viewing the image displayed on the display panel through the lens.

The HUD is configured to create a virtual image by magnifying an image displayed on a display panel through the lens, by reflecting the magnified image from a half minor, and by enabling a reflected light to be viewed by the user. The half mirror is configured to transmit an external light and thus, the user may view a front view together with the virtual image created by the HUD using the external light that transmits the half mirror.

The display device may be configured using various transparent display methods such as a transparent organic light emitting diode (TOLED).

Hereinafter, an embodiment of the present invention will be described based on an example in which the wearable electronic device 1 includes the HUD. However, the present invention is not limited thereto.

Referring to a configuration of a rear surface of the wearable electronic device 1 of FIG. 2, HUDs 150 and 151 performing a function similar to a projector may be mounted on a rear surface of at least one of the left side arm 30 and the right side arm 31.

An image by a light emitted from the HUDs 150 and 151 is viewed by the user by being reflected from the left and right lenses 50 and 51. Accordingly, the user may recognize that objects 200 created by the HUDs 150 and 151 are displayed on the left and right lenses 50 and 51.

In this case, as illustrated in FIG. 3, the objects 200 and a front view 250 displayed on the left and right lenses 50 and 51 by the HUDs 150 and 151 may be observed together at a sight of the user.

The object 200 to be displayed on the left and right lenses 50 and 51 by the HUDs 150 and 151 is not limited to a menu icon of FIG. 3 and may be an image such as a text, a photo, or a moving picture.

Through the configuration of the wearable electronic device 1 described above with reference to FIGS. 1 and 2, the wearable electronic device 1 may perform functions such as photographing, calling, a message, a social network service (SNS), a navigation, and a search.

In addition to the above functions, a variety of functions may be added to the wearable electronic device 1 based on modules included in the wearable electronic device 1.

For example, functions in which at least two functions, such as transmitting a moving picture taken through the camera 110 to an SNS server through the communicator 140 and thereby sharing the moving picture with other users, are fused may be configured.

Further, a three-dimensional (3D) glass function that enables the user to view a cubic image may be configured in the wearable electronic device 1.

For example, in response to an external display device alternately displaying a left-eye image or a right-eye image based on a frame unit, the wearable electronic device 1 may selectively open or block both eyes of the user and enables the user to perceive the 3D effect.

That is, the wearable electronic device 1 enables the user to perceive the 3D effect of a 3D image by opening a shutter on the left-eye side of the user when displaying a left-eye image on the display device and by opening a shutter on the right-eye side of the user when displaying a right-eye image on the display device.

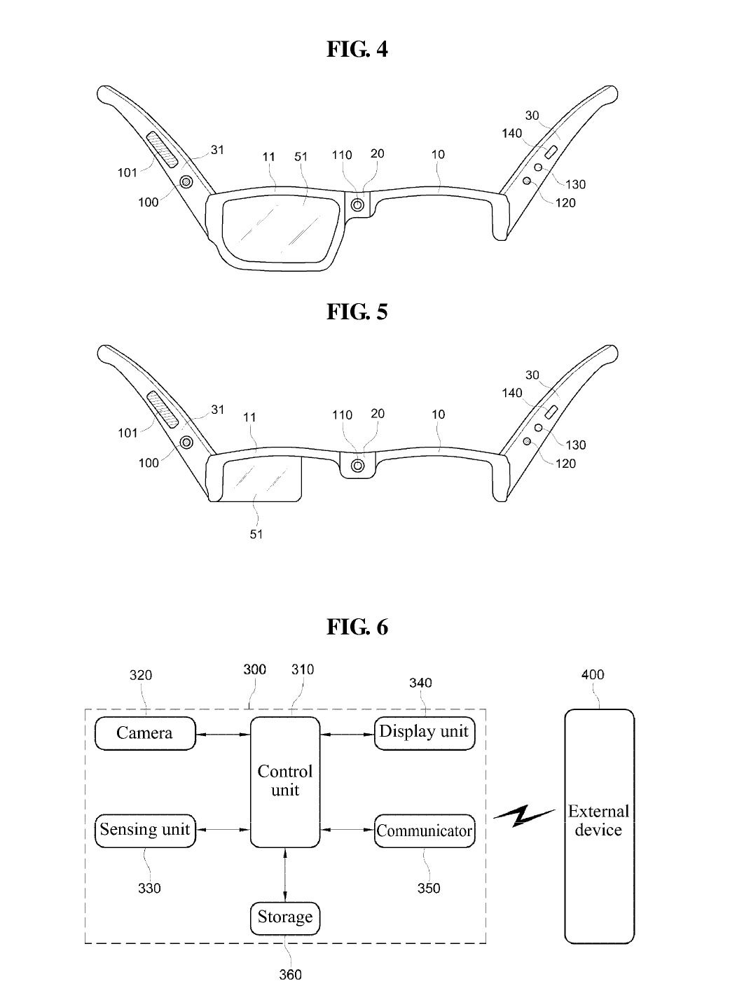

FIGS. 4 and 5 are perspective views illustrating a configuration of a wearable electronic device according to another embodiment of the present invention.

Referring to FIG. 4, the wearable electronic device 1 may include only one of left and right lenses, for example, only the right lens 51, so that an image displayed on a display device, for example, an HUD, inside the wearable electronic device 1 may be viewed at only one eye.

Referring to FIG. 5, the wearable electronic device 1 may be configured in a structure in which one eye portion, for example, a left eye portion of a user is completely open without being covered with a lens and only an upper portion of the other eye portion, for example, a right eye portion of the user is partially covered by the lens 11.

The shape and the configuration of the wearable electronic device 1 as above may be selected or changed based on various requirements such as a field of use, a primary function, and a primary use stratum.

Hereinafter, a method of controlling a wearable electronic device according to an embodiment of the present invention will be described with reference to FIGS. 6 through 35.

FIG. 6 is a block diagram illustrating a configuration of a wearable electronic device according to an embodiment of the present invention. A wearable electronic device 300 of FIG. 6 may include a control unit 310, a camera 320, a sensing unit 330, a display unit 340, a communicator 350, and a storage 360.

Referring to FIG. 6, the control unit 310 generally controls the overall operation of the wearable electronic device 300, and performs a control and processing associated with, for example, photographing, calling, a message, an SNS, a navigation, and a search. Also, the control unit 310 may include a multimedia module (not shown) to play back multimedia, and the multimedia module 181 may be configured within the control unit 180 and may also be configured separate from the control unit 310.

The control unit 310 may include one or more processors and a memory to perform the aforementioned function, and may serve to process and analyze signals input from the camera 320, the sensing unit 330, the display unit 340, the communicator 350, and the storage 360.

The camera 320 processes an image frame, such as a still image or a moving picture captured by an image sensor in a video call mode or a photographing mode. The processed image frame may be displayed on the display unit 340.

The image frame processed by the camera 320 may be stored in the storage 360 or may be transmitted to an outside through the communicator 350. At least two cameras 320 may be provided at different locations.

The sensing unit 330 may obtain bio-information of the user, for example, a blood pressure, blood glucose, pulse, electrocardiogram (ECG), a body heat, quantity of motion, a face, an iris, and a fingerprint, together with information associated with the wearable electronic device 300, and may include one or more sensors configured to obtain the bio-information.

According to an embodiment of the present invention, the control unit 310 may perform a user authentication operation of verifying a user based on bio-information of the user obtained by the sensing unit 330, and may control a function of the wearable electronic device 300 based on a result of the verifying.

The storage 360 may store a program for an operation of the control unit 310, and may temporarily store input/output data, for example, a message, a still image, and a moving picture.

The storage 360 may include storage media of at least one type among a flash memory type, a hard disk type, a multimedia card micro type, a card type memory, for example, a secure digital (SD) or an XD memory, a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

Also, the wearable electronic device 300 may operate in association with a web storage that performs a storage function of the storage 360 on the Internet.

The display unit 340 displays (outputs) information processed by the wearable electronic device 300. For example, the display unit 340 may display a user interface (UI) or a graphic user interface (GUI) associated with a call when the wearable electronic device 300 is in a call mode and may display a captured or/and received image or a UI or a GUI when the wearable electronic device 300 is in a video call mode or a photographing mode.

As described above with reference to FIGS. 1 through 3, the display unit 340 may be configured using a transparent display method such as an HMD, a HUD, or a TOLED, so that the user may visually recognize an object displayed on the display unit 340 together with a front view ahead.

The communicator 350 may include one or more communication modules configured to enable data communication between the wearable electronic device 300 and an external device 400. For example, the communicator 350 may include a broadcasting receiving module, a mobile communication module, a wireless Internet module, a near field communication module, and a location information module.

The wearable electronic device 300 may further include an interface unit (not shown) to function as a path with all the external devices connected to the wearable electronic device 300.

The interface unit serves to receive data from the external device, to be supplied with a power to transfer the power to each constituent element of the wearable electronic device 300, or to transmit inside data of the wearable electronic device 300 to the external device.

For example, a wired/wireless headset port, an external charger port, a wired/wireless data port, a memory card port, a port that connects a device including an identification module, an audio input/output (I/O) port, a video I/O port, and an earphone port may be included in the interface unit.

The identification module refers to a chip storing various types of information to authenticate a right to use the wearable electronic device 300, and may include, for example, a user identify module (UIM), a subscriber identify module (SIM), and a universal subscriber identity module (USIM). The device (hereinafter, an identify device) including the identification module may be manufactured in a smart card form. Accordingly, the identify device may be connected to the wearable electronic device 300 through a port.

Also, the interface unit may function as a path via which a power is supplied from a cradle to the wearable electronic device 300 in response to a connection between the wearable electronic device 300 and the cradle, or may function as a path via which various command signals input from the cradle is transferred to a mobile terminal by the user. Various command signals or the power input from the cradle may act as a signal for recognizing that the mobile terminal is accurately mounted to the cradle.

The wearable electronic device 300 may further include a power supplier (not shown) to be applied with a power from inside and outside the wearable electronic device 300 and to supply the power required for an operation of each constituent element. The power supplier may include a system chargeable using solar energy.

Various embodiments described herein may be configured in a computer or a non-transitory recording medium similar thereto using, for example, software, hardware, or combination thereof. According to a hardware configuration, the embodiments may be configured using at least one of application specific integrated circuits (ASICs), digital signal processors (DSPs), digital signal processing devices (DSPDs), programmable logic devices (PLDs), field programmable gate arrays (FPGAs), processors, control units, micro-controllers, microprocessors, and electrical units for performing functions. In some cases, the embodiments may be configured by the control unit 180.

According to a software configuration, embodiments such as procedures or functions may be configured together with a separate software module configured to perform one or more functions or operations. A software code may be configured by a software application written in an appropriate program language. Also, the software code may be stored in the memory unit 360, and may be executed by the control unit 310.

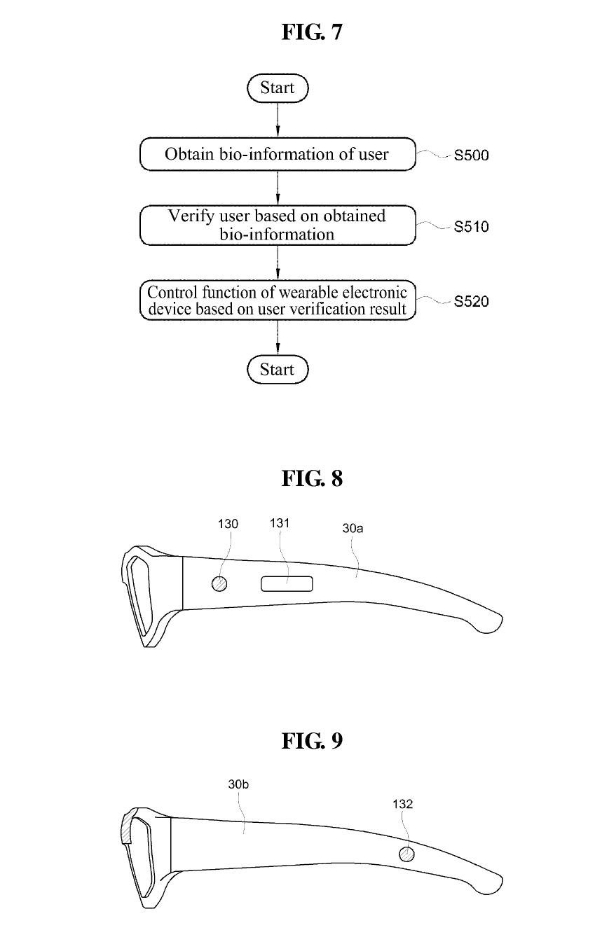

FIG. 7 is a flowchart illustrating a controlling method according to an embodiment of the present invention. The controlling method will be described with reference to a configuration of the wearable electronic device 300 of FIG. 6.

Referring to FIG. 7, in operation S500, the sensing unit 330 of the wearable electronic device 300 obtains bio-information of a user.

The bio-information of the user refers to information used to verify a user wearing the wearable electronic device 300, and may be, for example, information capable of accurately identifying the user or information capable of schematically categorizing the user, such as a sex, an age, or a current state of the user.

To this end, the sensing unit 330 may include a blood pressure measurement sensor, a blood glucose measurement sensor, a pulse measurement sensor, an ECG measurement sensor, a temperature measurement sensor, a quantity of motion measurement sensor, a facial recognition module, an iris recognition module, or a fingerprint recognition module. As described above, the bio-information measurement/recognition module may be mounted at a location at which corresponding bio-information is most accurately measurable or recognizable.

For example, as described above, the sensing unit 130 for detecting a motion, a location, and peripheral information, for example, a temperature, a humidity, noise, the direction of wind, and an air volume, of the wearable electronic device 300 may be mounted on an outer surface 30a of a side arm as illustrated in FIG. 8.

Also, referring to FIG. 8, when a fingerprint recognition module 131 is mounted on the outer surface 30a of the side arm and a user contacts any finger at a corresponding location, the fingerprint recognition module 131 may recognize a fingerprint and transfer fingerprint information to the control unit 310.

Referring to FIG. 9, a pulse measurement module 132 is mounted on an inner surface 30b of a side arm, more particularly, at a location adjacent to an ear of the user when the user wears the wearable electronic device 300. When the user wears the wearable electronic device 300 in a type of glasses, the pulse measurement module 132 may automatically measure the pulse of the user and may transfer corresponding information to the control unit 310.

Referring to FIG. 11, iris recognition modules 133 and 134 are mounted on inner surfaces 10b and 11b of lens frames, respectively. When the user wears the wearable electronic device 300, the iris recognition modules 133 and 134 may automatically recognize irises of the user and may transfer corresponding information to the control unit 310.

Meanwhile, the camera 320 may perform the aforementioned functions of the sensing unit 330 and may take a photo of a pupil, a partial face, an iris, or a fingerprint of the user, thereby enabling user bio-information to be obtained.

A microphone (not shown) performs the aforementioned functions of the sensing unit 330 whereby a voice of the user is recognized through the microphone and transferred to the control unit 310. Through this, the user voice may also be used to identify the user.

The control unit 310 verifies the user based on user bio-information obtained by the sensing unit in operation S510, and controls a function of the wearable electronic device based on the user verification result in operation S520.

According to an embodiment of the present invention, the user verification result may be indicated using an indicator provided to the wearable electronic device 300.

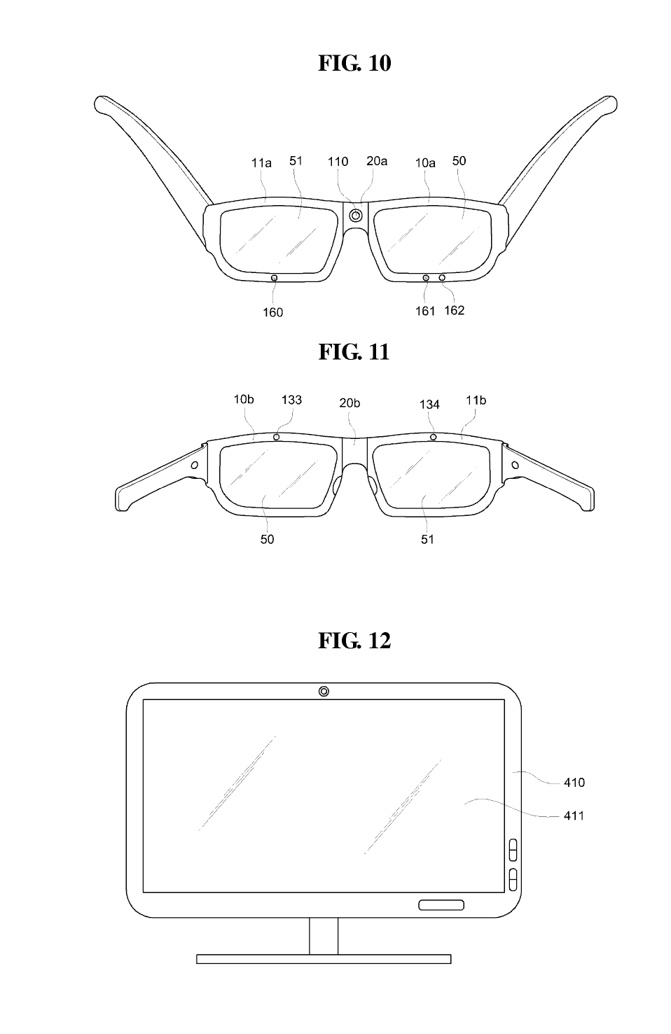

Referring to FIG. 10, the wearable electronic device 300 may include one or more indicators, for example, a first indicator 160, a second indicator 161, and a third indicator 162 capable of indicating a current state. The first indicator 160, the second indicator 161, and the third indicator 162 may be located on front surfaces 10a and 10b of lens frames to be well viewed from the outside.

The first indicator 160, the second indicator 161, and the third indicator 162 may include a luminous element such as a light emitting diode (LED) for displaying a light in predetermined color, and may flicker or be displayed using different colors based on information to be displayed.

For example, the first indicator 160 may flicker to indicate that the wearable electronic device 300 is currently taking a photo or a moving picture. In more detail, the first indicator 160 may be turned on only during taking a photo or a moving picture or may be displayed in red during taking.

Also, the second indicator 161 may indicate whether the user currently wearing the wearable electronic device 300 is an authenticated user. Flickering or a color of the second indicator 161 may be controlled based on the user verification result performed in operation S510.

For example, when an unauthenticated user is wearing the wearable electronic device 300, the second indicator 161 may be turned on or displayed in red. The third indicator 162 may indicate that currently viewing content is inappropriate for the user wearing the wearable electronic device 300.

For example, when the currently viewing content is inappropriate for children or juveniles and the user wearing the wearable electronic device 300 is not authenticated as an adult, the third indicator 162 may be turned on or displayed in red.

As described above, a user authentication result according to a user verification performed by the control unit 310 may be transferred to a designated external device through the communicator 350.

For example, when an unauthenticated user is wearing the wearable electronic device 300, the corresponding information may be transferred to a portable terminal corresponding to a designated number to inform an authenticated user that the unauthenticated user is wearing the wearable electronic device 300.

Although the controlling method of the wearable electronic device 300 according to an embodiment of the present invention is described above with reference to FIGS. 6 through 11, the present invention is not limited thereto.

For example, the wearable electronic device 300 may include a proximity sensor (not shown) to recognize whether the user is wearing the wearable electronic device 300. The control unit 310 may control the wearable electronic device 300 to operate in a standby mode in which most functions are in an inactive state when the wearable electronic device 300 is not worn by the user.

The proximity sensor refers to a sensor to detect a presence or absence of an object approaching a predetermined detection surface or an object present around the proximity sensor using a force of an electromagnetic field or IR rays and without using a mechanical contact. A lifecycle of the proximity sensor is longer than that of a contact-type sensor and the proximity sensor may be variously utilized.

Examples of the proximity sensor may include a permeable photoelectric sensor, a direct reflective photoelectric sensor, a mirror reflective photoelectric sensor, a high frequency oscillating proximity sensor, a capacitive proximity sensor, a magnetic proximity sensor, and an IR proximity sensor. When a touch screen is provided in a capacitive type, the touch screen is configured to detect a proximity of a pointer based on a change in an electric field occurring due to the proximity of the pointer. In this case, the touch screen, for example, a touch sensor may be classified as a proximity sensor.

Also, the wearable electronic device 300 may further include a haptic module (not shown) capable of generating various tactile effects perceivable by the user.

A representative example of the tactile effects generated by the haptic module may be a vibration. A strength and a pattern of vibration generated by the haptic module are controllable. For example, different vibrations may be synthesized and thereby output, or may be sequentially output.

In addition to the vibration, the haptic module may generate various tactile effects, for example, effects by alignment of pins performing a vertical motion with respect to a contacted skin surface, a jet force or a suction force of air through a jet orifice or a suction orifice, graze on a skin surface, a contact of an electrode, and a stimulus of an electrostatic force, and effects by representation of cold and warmth using a device capable of sucking or generating a heat.

Meanwhile, the haptic module may transfer a tactile effect through a direct contact or may enable a user to perceive the tactile effect through a muscle sense of a finger or an arm. At least two haptic modules may be provided based on a configuration of the wearable electronic device 300.

According to an embodiment of the present invention, the haptic module may serve to inform the user about information associated with a function of the wearable electronic device 300 according to a control of the control unit 310. For example, the haptic module may inform the user about start or end of a predetermined function or a predetermined state, or may transfer a different tactile effect to the user in response to an authentication success or an authentication failure based on the user authentication result as described above.

Hereinafter, a method of controlling a wearable electronic device based on a user authentication result according to a first embodiment of the present invention will be described with reference to FIGS. 12 through 17.

Referring to FIG. 12, a display device 410 such as a TV or a monitor may play back an image received from an outside or stored inside. However, the image being played back may be processed to be private so that the image being played back may not be viewed with naked eyes and thereby be displayed on a screen 411.

In this case, only a user granted a predetermined right, for example, only the user wearing the wearable electronic device 300 in a type of glasses according to an embodiment of the present invention may be allowed to view the image processed to be private and displayed on the screen 411 of the display device 410.

Since the image being played back by the display device 410 is content that requires a security or content that is to be limitedly viewed based on a user authentication result, such as an adult channel or a pay channel or a broadcasting after a predetermined time zone, a right to view the image may be intentionally limited on a user side or a content provider side.

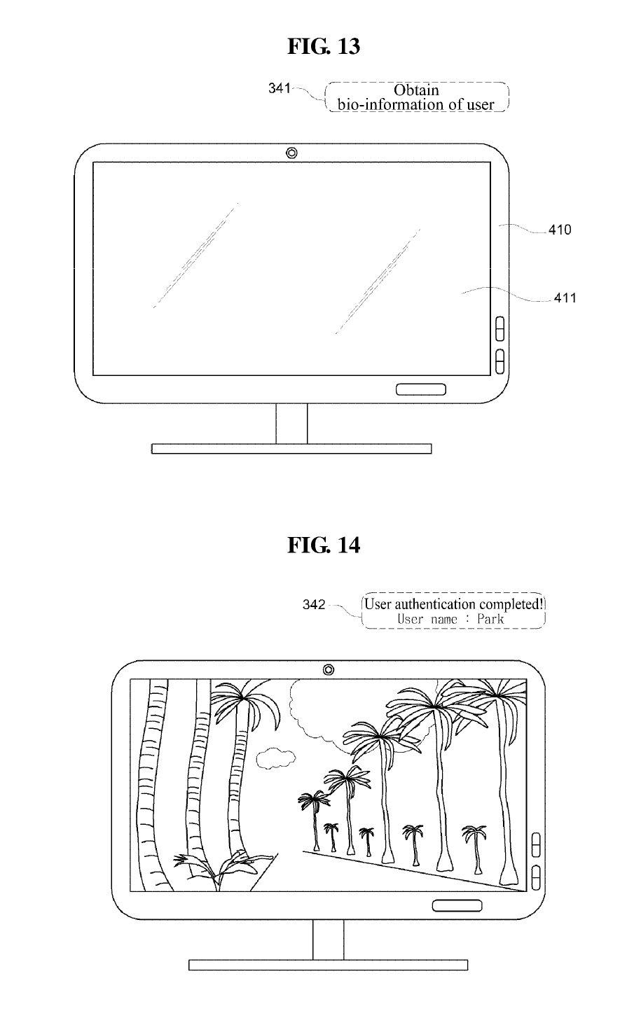

Referring to FIG. 13, when the user wears the wearable electronic device 300, the user authentication operation described above with reference to FIGS. 6 through 11 may be initially performed.

During the user authentication operation being performed, an object 342 for informing that user information is being verified may be displayed using the display unit 340 provided to the wearable electronic device 300.

The object 342 is displayed using an HMD, a HUD, or a TOLED to be recognized at a sight of the user together with a front view including a screen of the display device 410. The object 342 may be displayed at a location at which the screen of the display device 410 is not occluded.

In detail, when the control unit 310 compares user information obtained through the sensing unit 330, for example, user bio-information such as a partial face, an iris, a fingerprint, and a voice, to user information stored in the storage 360, and determines that when the user bio-information and the user information match as the comparison result, it is determined that an authenticated user is wearing the wearable electronic device 300.

In this case, referring to FIG. 14, an object 342 indicating that the user authentication is successfully completed is displayed using the display unit 340 of the wearable electronic device 300. The user may view content being played back on the screen 411 of the display device 410 through the wearable electronic device 300.

Also, a payment for a pay channel may be limited to be performed only when the user authentication succeeds. Payment information may use information stored in advance in the storage 360 with respect to the authenticated user.

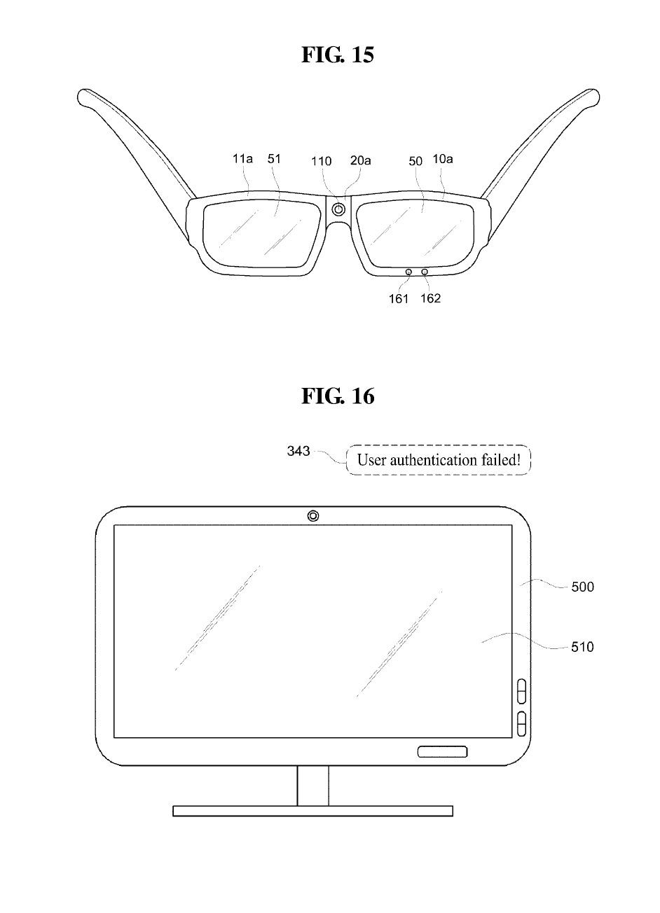

Referring to FIG. 15, when a user authentication is successfully completed, the second indicator 161 that is a blue LED may be turned on and persons around a user wearing the wearable electronic device 300 may recognize that an authenticated user is wearing the wearable electronic device 300.

Referring to FIG. 16, when a user wearing the wearable electronic device 300 is determined to be an unauthenticated user based on mismatch between user bio-information obtained through the sensing unit 330 and user information stored in the storage 360, an object 343 indicating a failure of a user authentication is displayed using the display unit 340 of the wearable electronic device 300 and the user may also view content being played back on the screen 411 of the display device 410 through the wearable electronic device 300.

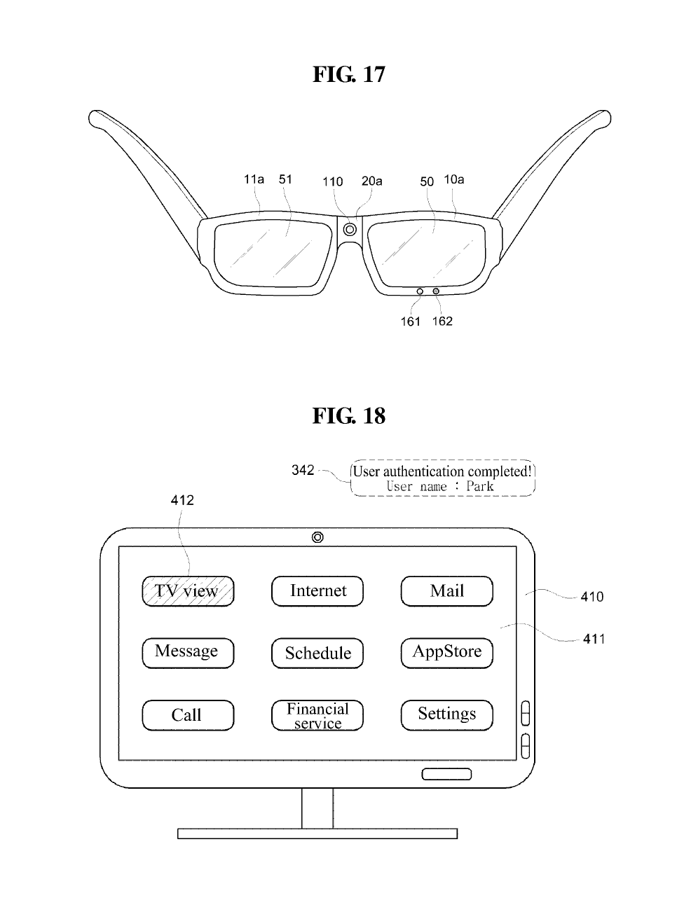

Referring to FIG. 17, when a user authentication fails, the third indicator 162 that is a red LED may be turned on and persons around the user may easily recognize that an unauthenticated user is wearing the wearable electronic device 300.

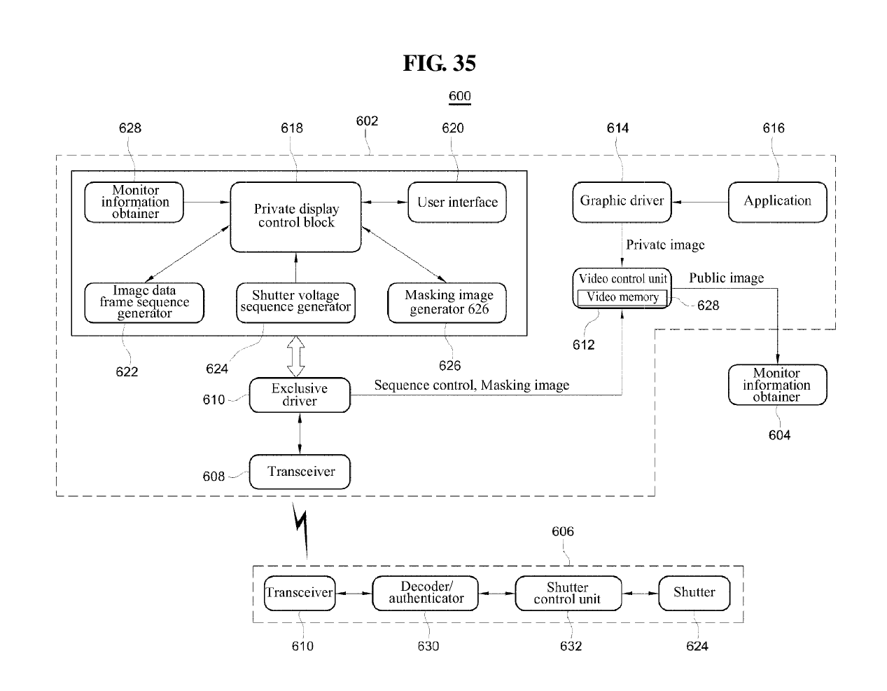

A method of displaying content in public or privately on the display device 410 based on a result of authenticating a user wearing the wearable electronic device 300 will be described with reference to FIG. 35. However, the present invention is not limited thereto and various known privacy view methods may be applicable.

According to an embodiment of the present invention, a view on a partial area of the screen 411 of the display device 410 or a partial configuration of content may be limited based on a user authentication result.

Hereinafter, a method of controlling a function of a wearable electronic device based on a user authentication result according to a second embodiment of the present invention will be described with reference to FIGS. 18 through 21.

Referring to FIG. 18, when an authenticated user wears the wearable electronic device 300, the user may verify menu items 412 corresponding to the entire functions executable at the display device 410 and then select a predetermined function.

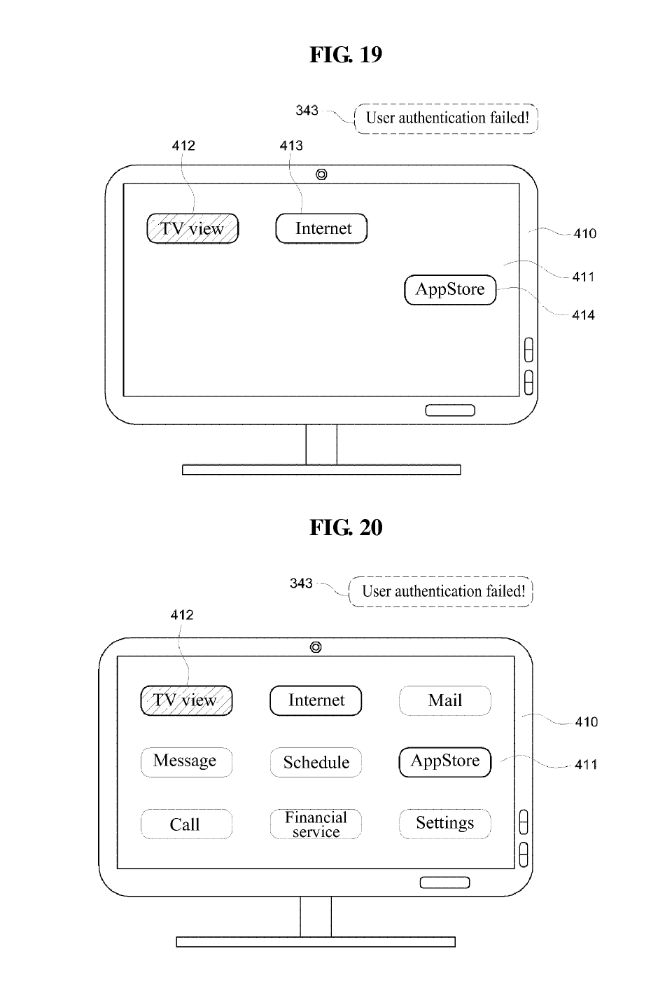

On the contrary, referring to FIG. 19, when an unauthenticated user wears the wearable electronic device 300, menu items, for example, “TV view”, “Internet”, and “applicationstore” icons, corresponding to a portion of the entire functions executable at the display device 410 may be recognized by the user, thereby limiting an executable function.

A function of the display device 410 is limited since a portion of the menu items displayed on the display device 410 is unseen to the user. Also, the execution itself of some functions may be limited in such a manner that the display device 410 receives information about the user authentication result from the wearable electronic device 300.

Referring to FIG. 20, in response to a failure of the user authentication through the wearable electronic device 300, menu items limited to an unauthenticated user may be displayed to be distinguished from remaining menu items and thereby be inactivated.

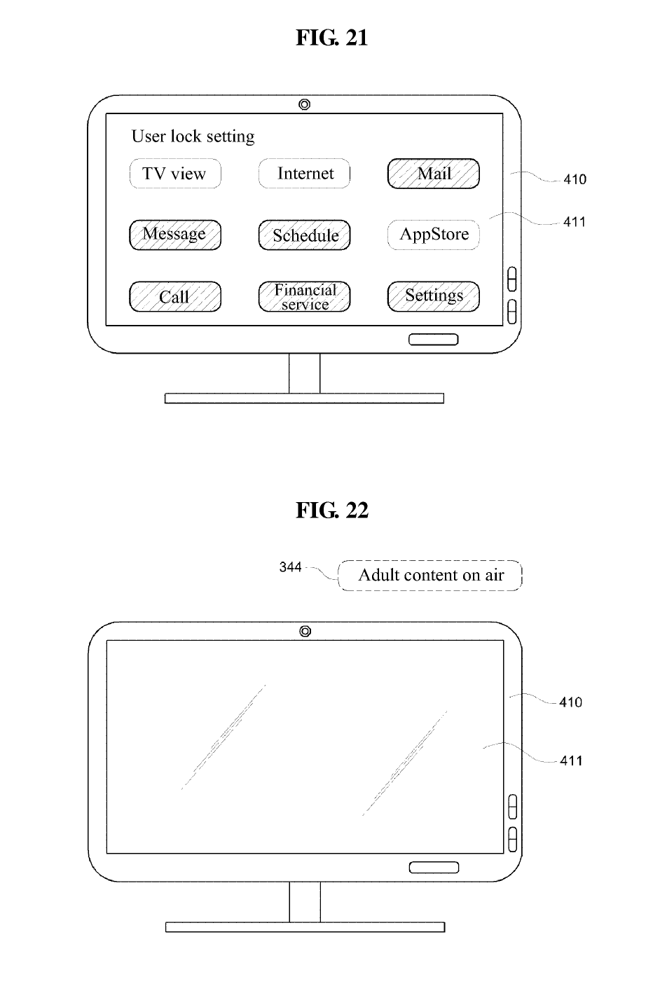

Referring to FIG. 21, an authenticated user may directly set functions to be limited against an unauthenticated user among functions of the display device 410 through a “user lock setting” menu.

Hereinafter, a method of controlling a function of a wearable electronic device based on an adult authentication result according to an embodiment of the present invention will be described with reference to FIGS. 22 through 24.

Referring to FIG. 22, when adult content is being played back on the display device 410, an object 344 indicating that the adult content is being played back may be displayed on the display unit 40 of the wearable electronic device 300. An image being played back on the screen 411 of the display device 410 may not be viewed by the user with naked eyes or with the wearable electronic device 300 on.

When the user wears the wearable electronic device 300, an adult authentication operation is performed to determine whether the user has a right to view the adult content.

For example, when the user wearing the wearable electronic device 300 is an authenticated user as a result of performing the user authentication operation, the adult authentication of the user may be performed based on age information of the authenticated user pre-stored in the storage 360.

According to an embodiment of the present invention, the control unit 310 may predict an age of the user wearing the wearable electronic device 300 based on bio-information of the user, such as a blood pressure, a blood glucose, a pulse, an ECG, a body heat, a quantity of motion, a face, a pupil, an iris, and a fingerprint obtained using the sensing unit 330.

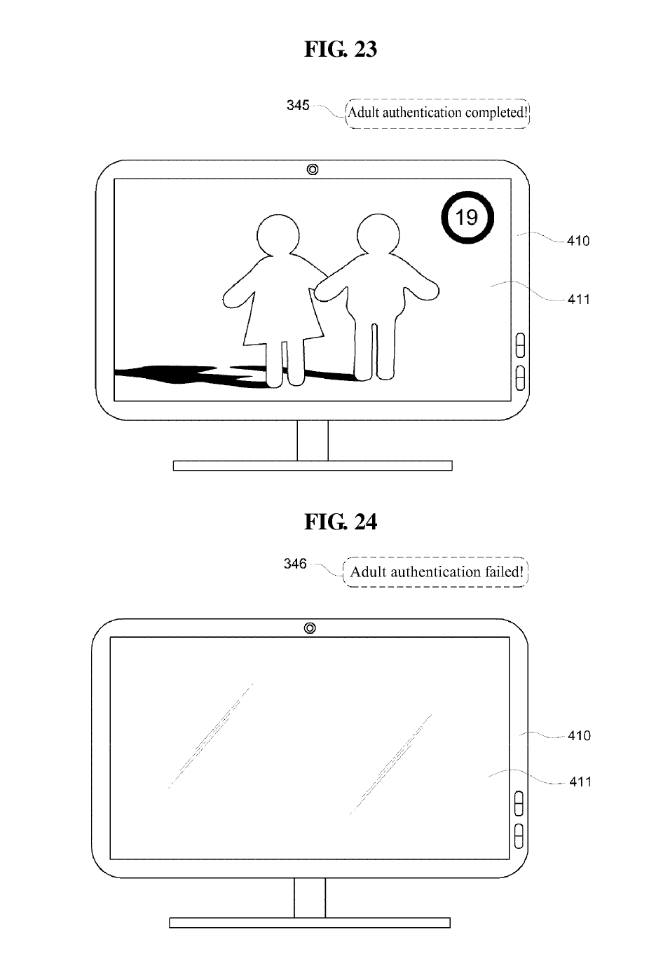

Referring to FIG. 23, when an adult authentication of the user is successfully completed, an object 345 indicating that the adult authentication is successfully completed may be displayed using the display unit 340 of the wearable electronic device 300 and the user may view the adult content being played back on the screen 411 of the display device 410 through the wearable electronic device 300.

Meanwhile, whether content being currently played back on the display device 410 is adult content may be determined based on an age restriction image 415 displayed on a predetermined area of the screen 411.

Referring to FIG. 24, when an adult authentication fails, an object 346 indicating a failure of the adult authentication may be displayed using the display unit 340 of the wearable electronic device 300 and the user may not view content being played back on the screen 411 of the display device 410 with naked eyes or using the wearable electronic device 300.

According to an embodiment of the present invention, a view limit may be set for each time zone.

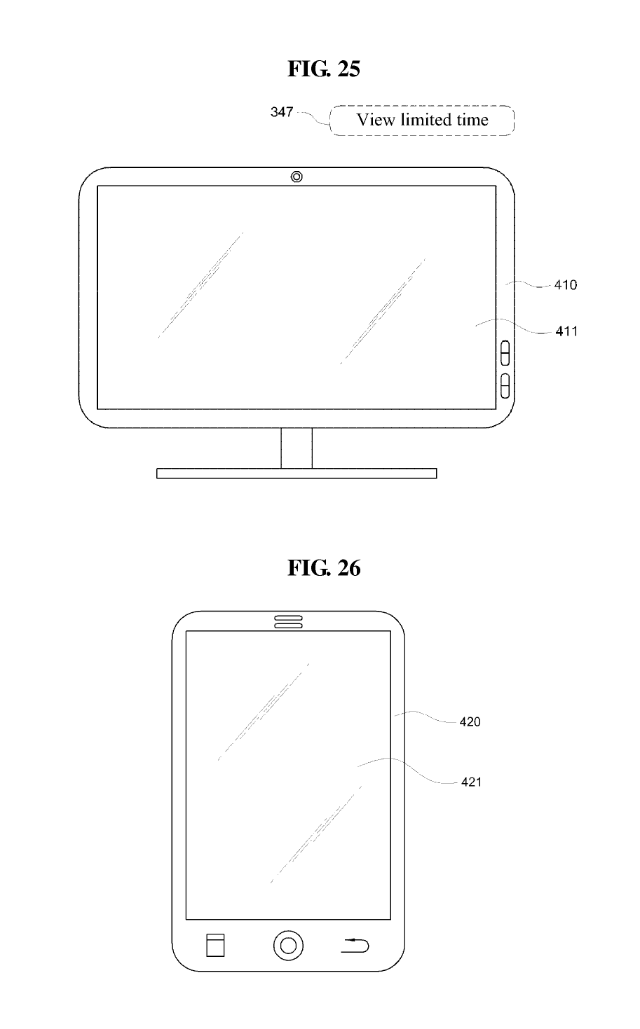

Referring to FIG. 25, when a current time is a time preset as a time zone in which a view is limited, an image being played back on the screen 411 of the display device 410 may not be viewed with naked eyes.

In this case, the image being played back on the display device 410 may be set to be viewed only when an authenticated user is wearing the wearable electronic device 300 by performing the aforementioned user authentication operation.

A method of limiting a view through a user authentication of the wearable electronic device 300 described above with reference to FIGS. 12 through 25 may be applicable to a portable terminal such as a desktop PC, a laptop, a personal digital assistant (PDA), or a mobile phone, in addition to a display device such as a TV or a monitor.

For example, a portable terminal device, such as a mobile phone, a PDA, and a laptop, and a desktop PC, is frequently used at public locations. Here, contents of a display monitor may be viewed by any person within a visible distance of the display.

Due to the above security issue, when using a computer for a text, a mail, a chat, or a moving picture, the user may have some constraints on using the computer for contents that are not to be viewed by other persons. In addition to a personal use of a computer, a privacy issue may arise even when the user works on a confidential document using a computer at a company or a government.

A security issue of a display may be present in various fields. For example, an automatic teller machine (ATM) is disposed at a public location and thus, a passcode key input of an ATM user and secret information such as a transaction on a screen may be easily exposed.

Accordingly, when a privacy view function of providing private information to an allowed user on a monitor visible in public and not allowing a disallowed user to view the private information on the same monitor is applied, it may be useful.

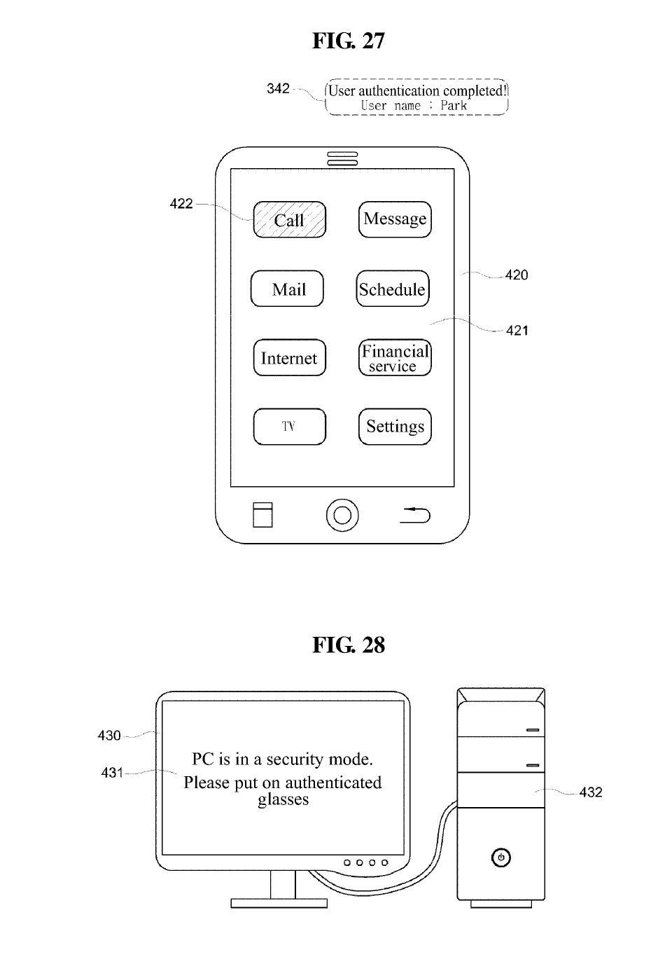

Hereinafter, a method of limiting a use of a portable terminal based on user information according to an embodiment of the present invention will be described with reference to FIGS. 26 and 27.

Referring to FIG. 26, when a view limit function of allowing only a user having a right to connect is set to a portable terminal 420, an image being displayed on a screen 421 of the portable terminal 420 may not be viewed with naked eyes.

In this case, the aforementioned user authentication operation is performed and the image being displayed on the screen 421 of the portable terminal 420 may be visually recognized only when an authenticated user is wearing the wearable electronic device 300.

For example, referring to FIG. 27, when an authenticated user is wearing the wearable electronic device 300, menu items 422 displayed on the screen 421 of the portable terminal 420 may be visually recognized to the user through the wearable electronic device 300.

Accordingly, an unauthenticated user may not visually recognize the image displayed on the portable terminal 420 with naked eyes or even with the wearable electronic device 300 on and thus, may not execute functions of the portable terminal 420.

FIGS. 28 through 30 are views describing a method of limiting a use of a PC based on user information according to an embodiment of the present invention.

Referring to FIG. 28, when a security setting of allowing an access of only a user granted a right is set to a PC 430, a text indicating that the PC is in a security mode may be displayed on a screen 431 of the PC 430 and a remaining image being displayed on the PC 430 may not be viewed with naked eyes.

In this case, the aforementioned user authentication operation is performed and the image being displayed on the screen 431 of the PC 430 may be visually recognized only when an authenticated user is wearing the wearable electronic device 300.

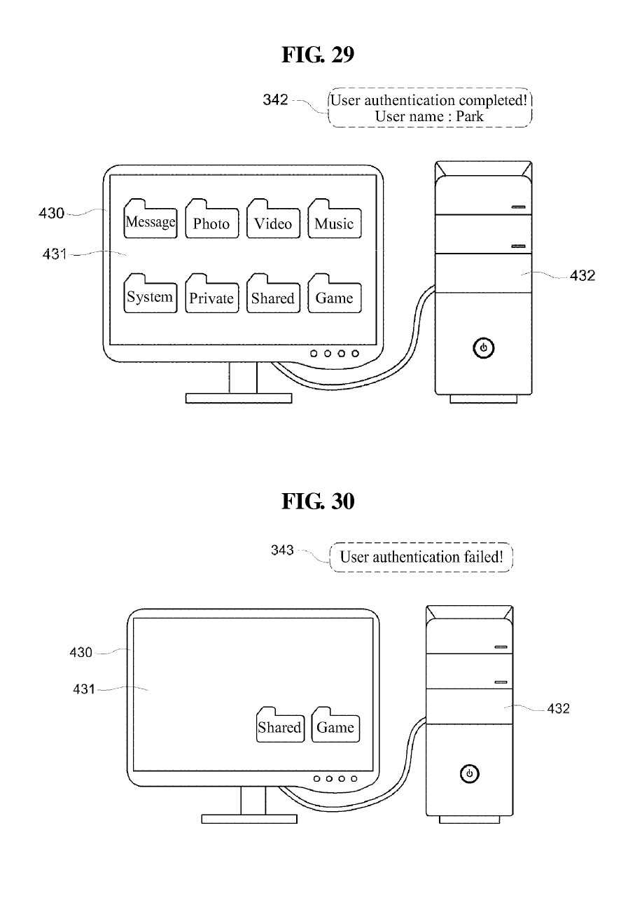

Referring to FIG. 29, when an authenticated user is wearing the wearable electronic device 300, folders displayed on the screen 431 of the PC 430 may be visually recognized by the user through the wearable electronic device 300.

An unauthenticated user may not visually recognize the image being displayed on the PC 430 with naked eyes or even with the wearable electronic device 300 on and accordingly, may not execute functions of the PC 430.

According to an embodiment of the present invention, only a portion of the folders of the PC 430 may be viewed to the unauthenticated user.

Referring to FIG. 30, when an unauthenticated user wears the wearable electronic device 300, only some folders to which a security is not set among the folders of the PC 430 may be visually recognized and accessible by the user through the wearable electronic device 300 and an access to the remaining folders may be limited.

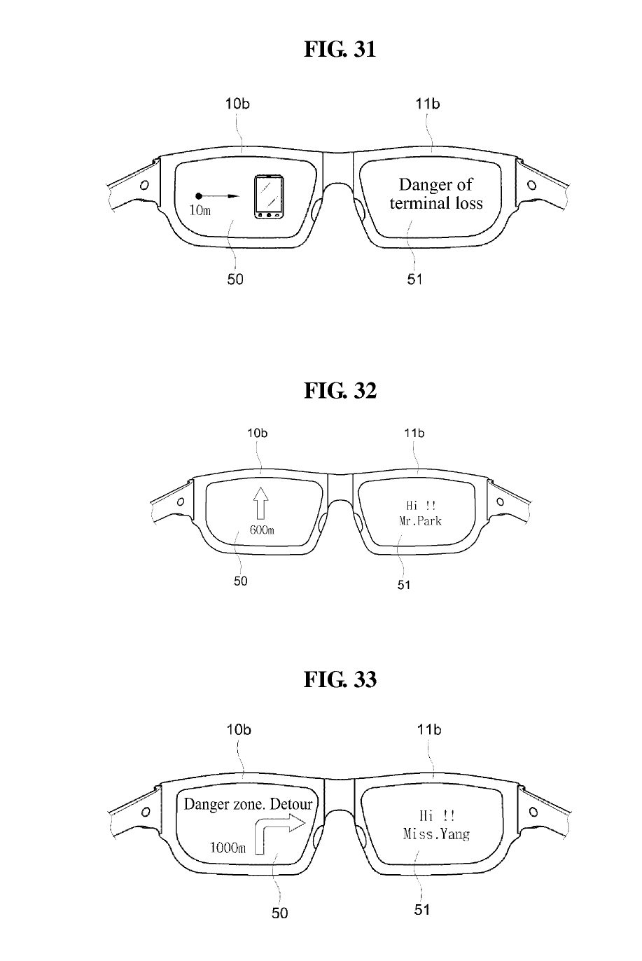

Hereinafter, various user interfaces configured on a wearable electronic device according to an embodiment of the present invention will be described with reference to FIGS. 31 through 33.

The wearable electronic device 1 according to an embodiment of the present invention and a predetermined portable terminal may be connected as a pair and share mutual information.

Referring to FIG. 31, when the wearable electronic device 1 is separate from the portable terminal by at least a predetermined distance, a danger of mutual loss may be informed.

For example, when the user wears the wearable electronic device 1 and a user authentication is successfully completed, a distance between the wearable electronic device 1 and the portable terminal may be measured through a communication with the portable terminal using portable terminal information, for example, a telephone number, pre-stored in the wearable electronic device 1.

As a result, when the distance between the wearable electronic device 1 and the portable terminal is greater than or equal to a preset distance, for example, 10 m, distance information and a danger of terminal loss may be informed using a display unit included in the wearable electronic device 1.

The distance between the wearable electronic device 1 and the portable terminal may be predicted by measuring communication strength through periodical performing of mutual near field communication.

According to an embodiment of the present invention, a personalized UI or service may be provided to the user based on user bio-information obtained by the wearable electronic device 1.

Referring to FIG. 32, when a user authentication is completed using user bio-information, a user-oriented navigation service may be provided through a display unit included in the wearable electronic device 1.

Meanwhile, referring to FIG. 33, when the user wearing the wearable electronic device 1 is a female or a child based on the user authentication result, a navigation service such as a route guide may be provided.

That is, a notification “go straight” may be provided to a male user of FIG. 32, and a danger zone or detour may be provided to a female user of FIG. 33.

FIGS. 32 and 33 describe an example of providing a user information tailored service through the wearable electronic device 1 according to an embodiment of the present invention. The user information tailored service may be applicable to various services such as photographing, calling, a message, and an SNS, in addition to the navigation service.

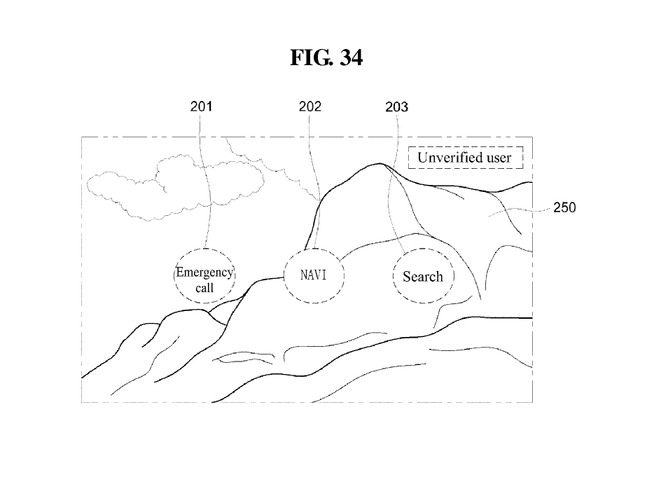

FIG. 34 illustrates another example of a view viewed by a user through a wearable electronic device. When an unauthenticated user wears the wearable electronic device 1, that the corresponding user is an unverified user may be displayed on a display unit of the wearable electronic device 1 and functions of the wearable electronic device 1 may be limited.

That is, by comparing FIGS. 3 and 34, only an emergency call function 201, a navigation function 202, and a search function 203 may be provided to the unverified user who is unauthenticated.

In embodiments of FIGS. 12 through 34, that a limited image is being viewed through the wearable electronic device 300 may be displayed through an indicator provided on a front surface of the wearable electronic device 300.

The wearable electronic device 1 according to an embodiment of the present invention may have a 3D view function. The 3D view function may be configured using a shutter glass method of alternately opening and closing a left glass and a right glass.

In this case, the wearable electronic device 1 may perform a view limit function using the shutter glass method.

FIG. 35 is a block diagram illustrating a configuration of a wearable electronic device according to another embodiment of the present invention. A wearable electronic device 606 may include a transceiver 610, a decoder/authenticator 630, a shutter control unit 632, and a shutter 624.

Referring to FIG. 35, a view limit system according to an embodiment of the present invention may include an image processing device 602, a display device 604, and the wearable electronic device 606.

The image processing device 602 may store and thereby include private display software in a non-transitory computer-readable memory. The image processing device 602 displays a private image and a masking image for masking the private image on the display device 604 in response to a request of a user or autonomously, and transmits a shutter open and close signal corresponding thereto to the wearable electronic device 606, thereby operating a shutter open and close device so that only an authenticated user may view the private image.

The shutter open and close device provided to the wearable electronic device 606 may be provided in a mechanical type or a photoelectric type such as a liquid crystal shutter, and may be provided in various types including one or more shutter lenses.

Functions aside from the shutter open and close device provided to the wearable electronic device 606 and a transmitting and receiving interface unit 608 may be configured as software.

Here, an exclusive driver 610 may indicate a driver that is separate from a graphic driver 614 within the image processing device 602 and approaches a video control unit 612, such as a graphic card, and configures a private display in real time.

A private display control block 618 includes a security performance control unit, an encoder, a user authenticator, and a manager, and may authenticate a user from a user interface 620, and may set and manage a display security level based on an authentication level of an allowed user and a user input.

A user authentication method may receive an identification number (ID) and a passcode of the user from the user interface 620 and may authenticate the user.

Also, the user authentication may be performed by connecting the wearable electronic device 606 worn by the authenticated user without input of the ID and the passcode. Also, the user authentication may be performed by connecting the allowed shutter open and close device of the wearable electronic device 606 and by receiving the ID and the passcode of the allowed user. Whether the shutter open and close device is allowed and a genuine product certification may be performed based on a serial number of a product embedded in a ROM (not shown) of the wearable electronic device 606.

The private display control block 618 receives display device information from a display device, for example, monitor, information obtainer 628, and controls an image data frame sequence generator 622, a shutter voltage sequence generator 624, and a masking image generator 626 based on an authentication level of the user and a display security level.

The display device information obtainer 628 reads information, for example, a resolution, a refresh cycle time, a vertical sync, and a horizontal sync of the display device 604.

The image data frame sequence generator 622, the shutter voltage sequence generator 624, and the masking image generator 626 generate an image data frame sequence, a shutter voltage sequence, and a masking image, respectively, based on an authentication level of the user, a display security level, and an additional selection of the user.

The shutter voltage sequence generator 624 generates a shutter open and close sequence by being synchronized with an image data frame sequence and generates a voltage sequence corresponding to the shutter open and close sequence.

The exclusive driver 610 provides, to a video memory 628, the masking image generated by the masking image generator 626 based on the generated image data frame sequence, or generates the masking image according to an instruction of the masking image generator 626 and provides the masking image to the video memory 628 or controls a change of a color table in real time.

Also, the exclusive driver 610 enables the video control unit 612 to switch a private image memory block and a masking image memory block based on the generated image sequence, and thereby controls an image transmission to the display device 604.

The transceiver 608 transmits a shutter open and close sequence or a shutter voltage sequence to the shutter open and close device of the wearable electronic device 606. Also, the transceiver 608 may transmit an encoded shutter voltage sequence to the allowed user using an encoder (not shown).

The transceiver 608 or 310 may be configured in a wired line such as a uniform serial bus (USB) and a serial link or a wireless link such as an IR and a radio frequency (RF), for example, FM, AM, and Bluetooth. The video control unit 612 such as a graphic card includes the video memory 628, and displays, on the display device 604, an original private image received from the graphic driver 614 and the masking image received from the exclusive driver 610, based on the image data frame sequence.

Referring to FIG. 35, the shutter open and close device of the wearable electronic device 606 may include the transceiver 610, the decoder/authenticator 630, the shutter control unit 632, and the shutter unit 634. The transceiver 610 receives the encoded shutter open and close signal transmitted from the transceiver 608 and transmits the received encoded shutter open and close signal to the decoder/authenticator 630.

The decoder/authenticator 630 generates the shutter voltage sequence by interpreting the shutter open and close signal. The shutter control unit 632 opens or closes the shutter unit 624 completely or to be in an intermediate state based on the shutter voltage sequence.

The display security level is set as a performance level according to a “naked eye security performance” with respect to a disallowed user not having a shutter and an “against-spy security performance” with respect to a disallowed user having a different shutter. In general, a “user visual perception performance” such as a user comfort about visual perception and a definition of an image decreases according to an increase in a display security level.

The display security level may be variously defined. For example, at a first level, a disallowed user may not perceive even an approximate type of a private user image although the disallowed user views a display device during a relatively long period of time, for example, a predetermined period of time or more.

As the strictest private information protection, for example, whether the user is using a word processor or viewing a moving picture may not be known. At a second level, a disallowed user may recognize an approximate type of a user image when the disallowed user views a display device during a predetermined period of time or more, however, may not verify even a portion of image information content. For example, the disallowed user may be aware of whether the user is viewing a moving picture, however, may not be aware of whether the moving picture is a movie or a chat.

At a third level, a disallowed user may approximately verify a portion of user image information content when the disallowed user views a display device during a predetermined period of time or more, however, may not verify most of user image information content. For example, the disallowed user may be unaware of content of a word processor being typed by the user. That is, the disallowed user may be aware that the moving picture viewed by the user is a movie, however, may be unaware of content thereof.

At a fourth level, a disallowed user may accurately verify a portion of user image information content when the disallowed user views a display device during a predetermined period of time or more, however, may not verify most of the user image information content. For example, the disallowed user may be slightly aware of content of a word processor being typed by the user. At a fifth level, the disallowed user may verify quite a portion of user image information content, however, may have discomfort in visual perception.

According to another embodiment, a level at which a user private image and an intentional disturbing masking image are recognizable by a disallowed user may be added to the above performance level as an additional performance index. In this case, various display security levels such as the performance level may be set.

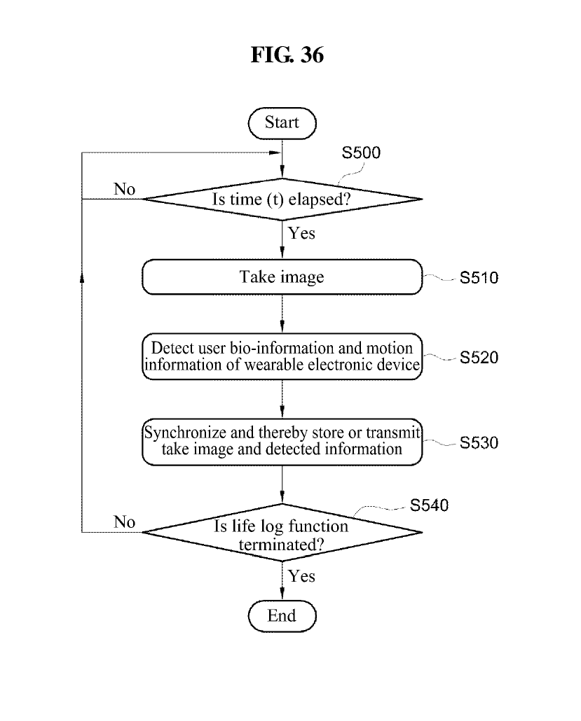

FIG. 36 is a flowchart illustrating a controlling method according to another embodiment of the present invention. The controlling method will be described with reference to the configuration of the wearable electronic device 300 of FIG. 6.

Referring to FIG. 36, periodically, for example, every time a predetermined time t is elapsed in operation S500, the camera 320 of the wearable electronic device 300 takes an image in operation S510 and at the same time, the sensing unit 330 detects user bio-information and motion information of the wearable electronic device 300 in operation S520.

The user bio-information refers to information used to verify a current state of the user wearing the wearable electronic device 300.

To this end, the sensing unit 330 may include a blood pressure measurement sensor, a blood glucose measurement sensor, a pulse measurement sensor, an ECG measurement sensor, a temperature measurement sensor, a quantity of motion measurement sensor, a facial recognition module, an iris recognition module, or a fingerprint recognition module. As described above, the bio-information measurement/recognition module may be mounted at a location at which corresponding bio-information is most accurately measurable or recognizable.

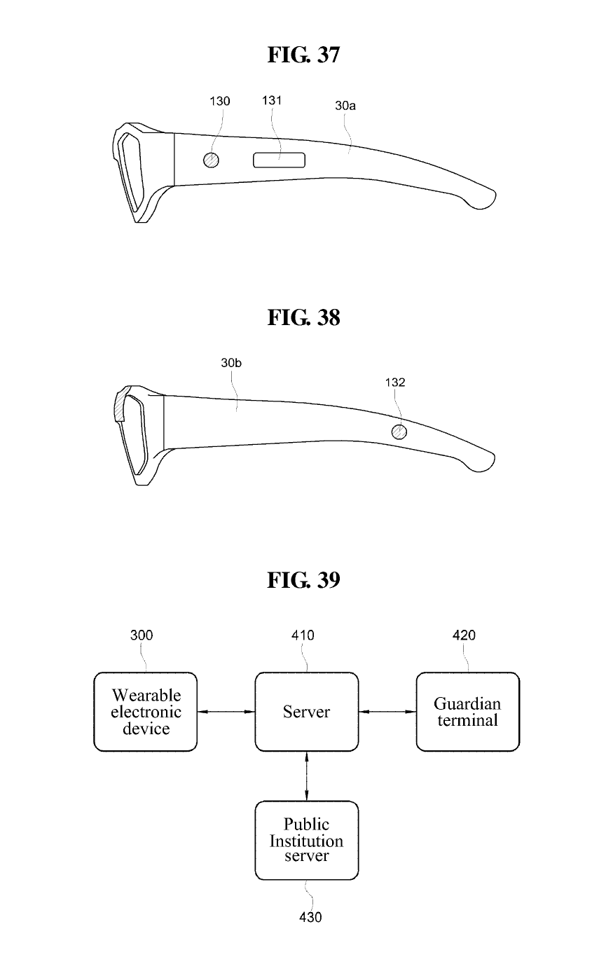

For example, as described above, the sensing unit 130 for detecting a motion, a location, and peripheral information, for example, a temperature, a humidity, noise, the direction of wind, and air volume, of the wearable electronic device 300 may be mounted on an outer surface 30a of a side arm as illustrated in FIG. 37.

Also, referring to FIG. 8, when a fingerprint recognition module 131 is mounted on the outer surface 30a of the side arm and a user contacts any finger at a corresponding location, the fingerprint recognition module 131 may recognize a fingerprint and transfer fingerprint information to the control unit 310.

Referring to FIG. 38, a pulse measurement module 132 is mounted on an inner surface 30b of a side arm, more particularly, at a location adjacent to an ear of the user when the user wears the wearable electronic device 300. When the user wears the wearable electronic device 300 in a type of glasses, the pulse measurement module 132 may automatically measure the pulse of the user and may transfer corresponding information to the control unit 310.

Meanwhile, the camera 320 may perform the aforementioned functions of the sensing unit 330 and may take a photo of a pupil, a partial face, an iris, and the like, of the user, thereby enabling user bio-information to be obtained or enabling a peripheral dangerous situation to be recognized from the taken image.

A microphone (not shown) performs the aforementioned functions of the sensing unit 330. Accordingly, a situation such as ambient noise may be obtained.

In operation S530, the control unit 310 synchronizes and thereby stores or transmits the image taken by the camera 320 and information detected by the sensing unit 330.

For example, the control unit 310 may synchronize and thereby manage the image and the information based on a time at which the image is taken using the camera 320 and a time at which the information is detected using the sensing unit 330.

In operation S540, the control unit 310 controls a process of operations S510 through S530 to be periodically performed until a life log function is terminated.

Meanwhile, since a large amount of information may be detected by the sensing unit 330, the control unit 310 may process the detected information and may determine the processed information as a predetermined danger item or level such as “Emergency! No pulse”, “Emergency! Compulsory release”.

In detail, when the wearable electronic device 300 is set to take a moving picture for five seconds every five minutes and to synchronize the taken moving picture and relevant information periodically, the control unit 310 may classify and manage acts of the user performed for the last one month using an image recognition search, based on user bio-information and peripheral information.

For example, information about foods that the user had for the last one month may be provided together with relevant photos. Accordingly, the user may refer to the information and photos when planning a diet and selecting a current meal menu in addition to reminiscences about the last one month.

The control unit 310 may determine whether the periodically taken image corresponds to a unique situation based on each danger level, each interest of user, a record and transmission value index, or cost for record and transmission. When the periodically taken image is determined to be the unique situation, the control unit 310 may transmit the image and the measured information to the storage 360 through the sensing unit 330 or may transmit the same to the external device 400 through the communicator 350.

Although the controlling method of the wearable electronic device 300 according to an embodiment of the present invention is described above with reference to the accompanying drawings, the present invention is not limited thereto.

For example, the wearable electronic device 300 may include a proximity sensor (not shown) to recognize whether the user is wearing the wearable electronic device 300. The control unit 310 may control the wearable electronic device 300 to operate in a standby mode in which most functions are in an inactive state when the wearable electronic device 300 is not worn by the user.

The proximity sensor refers to a sensor to detect a presence or absence of an object approaching a predetermined detection surface or an object present around the proximity sensor using a force of an electromagnetic field or IR rays and without using a mechanical contact. A lifecycle of the proximity sensor is longer than that of a contact-type sensor and the proximity sensor may be variously utilized.

Examples of the proximity sensor may include a permeable photoelectric sensor, a direct reflective photoelectric sensor, a mirror reflective photoelectric sensor, a high frequency oscillating proximity sensor, a capacitive proximity sensor, a magnetic proximity sensor, and an IR proximity sensor. When a touch screen is provided in a capacitive type, the touch screen is configured to detect a proximity of a pointer based on a change in an electric field occurring due to the proximity of the pointer. In this case, the touch screen, for example, a touch sensor may be classified as a proximity sensor.

Also, the wearable electronic device 300 may further include a haptic module (not shown) capable of generating various tactile effects perceivable by the user.

A representative example of the tactile effects generated by the haptic module may be a vibration. A strength and a pattern of vibration generated by the haptic module are controllable. For example, different vibrations may be synthesized and thereby output, or may be sequentially output.

In addition to the vibration, the haptic module may generate various tactile effects, for example, effects by alignment of pins performing a vertical motion with respect to a contacted skin surface, a jet force or a suction force of air through a jet orifice or a suction orifice, graze on a skin surface, a contact of an electrode, and a stimulus of an electrostatic force, and effects by representation of cold and warmth using a device capable of sucking or generating a heat.

Meanwhile, the haptic module may transfer a tactile effect through a direct contact or may enable a user to perceive the tactile effect through a muscle sense of a finger or an arm. At least two haptic modules may be provided based on a configuration of the wearable electronic device 300.

According to an embodiment of the present invention, the haptic module may serve to inform the user about information associated with a function of the wearable electronic device 300 according to a control of the control unit 310. For example, the haptic module may inform the user about start or end of a predetermined function or a predetermined state, or may inform the user about whether the aforementioned unique situation has occurred using a tactile effect.

FIG. 39 is a block diagram illustrating a configuration of a user danger detection system according to an embodiment of the present invention. A danger detection system may include a wearable electronic device 300, a server 410, a guardian terminal 420, and a public institution server 430.

Referring to FIG. 39, the wearable electronic device 300 may periodically take an image and may synchronize and thereby store the taken image and user bio-information, motion information, and peripheral situation information at a point in time at which the image is taken.

Also, when the synchronized information satisfies a predetermined condition, for example, when the synchronized information is determined as a dangerous situation or a unique situation based on the detected information, the wearable electronic device 300 may transmit information associated with the synchronized image to the server 410.

Meanwhile, the server 410 may store and manage information associated with the image received from the wearable electronic device 300, and may transmit at least one item of information associated with the received image to the guardian terminal 420.

Also, the server 410 may transmit at least one item of information associated with the image received from the wearable electronic device 300 to the public institution server 430 such as a police station and a hospital, such that information about a dangerous situation may be provided.

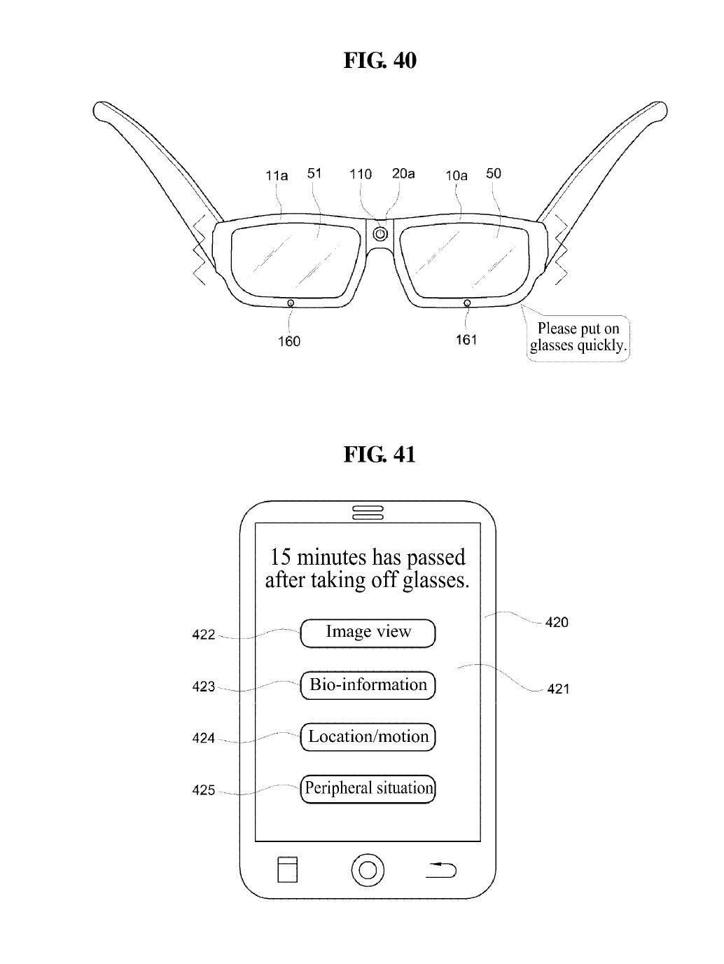

Hereinafter, a method of processing an image and information obtained by the wearable electronic device 300 according to embodiments of the present invention will be described with reference to FIGS. 40 through 46.

According to an embodiment of the present invention, a user interface for informing a take-off situation when a user takes off the wearable electronic device 300 may be provided.

Referring to FIG. 40, if a predetermined tolerance time is elapsed after the user takes off the wearable electronic device 300 in a type of glasses, for example, in 10 minutes after take-off, the user may be informed using a vibration or a voice that the user needs to quickly wear the wearable electronic device 300.

At the same time when, or if a predetermined period of time is elapsed after the user takes off the wearable electronic device 300, for example, in 15 minutes after take-off, images and relevant information synchronized by the control unit 310 and thereby stored in the storage 360 may be transmitted to the server 410 and may be transferred to the guardian terminal 420 through the server 410.

Referring to FIG. 41, if 15 minutes is elapsed after the user takes off the wearable electronic device 300, corresponding information may be transferred to the guardian terminal 420 through the server 410 and be displayed on a screen 420.

Also, menu items 422, 423, 424, and 425 for verifying details about a situation at a take-off point in time may be displayed on the screen 420 of the guardian terminal 420.

For example, a guardian may verify images periodically taken by the wearable electronic device 300 by a take-off point in time by selecting the menu item 422 “image view”, or may verify a blood pressure, a blood glucose, a pulse, an ECG, a body heat, a quantity of motion, a face, and an iris state temporally synchronized with an image by selecting the menu item 423 “bio-information”.

Also, the guardian may verify motion or location information of the user by the take-off point in time by selecting the menu item 424 “location/motion”, or may verify a peripheral situation such as a temperature, a humidity, an air volume, and noise by selecting the menu item 425 “peripheral situation”.

Referring to FIG. 40, according to another embodiment of the present invention, the guardian enables a put-on notification function to be executed at the wearable electronic device 300 using the guardian terminal 420. This function may be operated through the server 410.

Meanwhile, the aforementioned controlling operation of the wearable electronic device 300 may be performed for each danger level and each interest of user, or may be differently performed based on an index calculated in terms of transmission value and cost.

For example, when information associated with the synchronized image is excessively transmitted in a general situation, a power of the wearable electronic device 300 may be unnecessarily used, thereby making it difficult to cope with an emergency or dangerous situation. A sensing value having a relatively high importance and a relatively small amount of information, such as a pulse or a location of the user may have a relatively high total value against cost. On the contrary, an image or a voice may have a relatively low total value compared to a battery consumption and a data amount.

Accordingly, the control unit 310 of the wearable electronic device 300 may store a corresponding image and relevant information or may determine whether to transmit the image and the relevant information to an outside, while correcting the transmission value and cost based on previous experience values stored in the wearable electronic device 300, the server 410, and the guardian terminal 420.

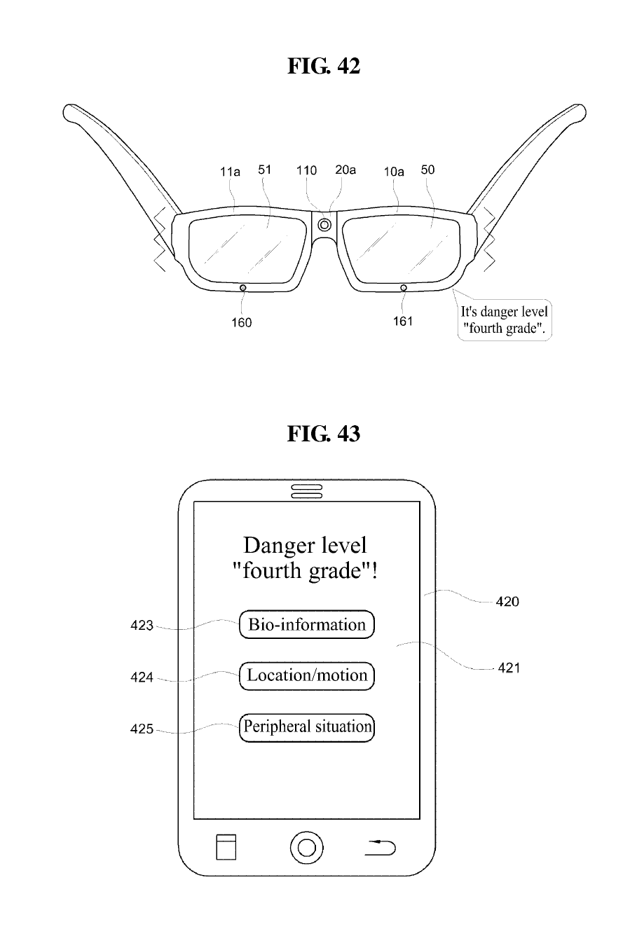

Hereinafter, a user information for informing a state of a user based on a danger level of the user according to an embodiment of the present invention will be described with reference to FIGS. 42 through 46.

Initially, an upper limit value and a lower limit value may be preset with respect to information detected through the sensing unit 330 of the wearable electronic device 300, for example, an acceleration, a speed, a pulse rate, a heart rate, a blood pressure, and a body heat of the user.

Meanwhile, the user or a guardian of the user may directly set the upper limit value and the lower limit value. The user may set a safe location.

In this case, a danger level of the user may be determined by comparing information detected through the sensing unit 330 to the set upper and lower limit values and safe location.

For example, a danger level “fourth grade” may indicate a case in which a pulse rate and an instantaneous acceleration of the user exceed an upper limit value.

Meanwhile, in response to an occurrence of a dangerous situation, the wearable electronic device 300 may preferentially transmit information having a relatively high importance or a relatively small amount of data to the server 410, and may increase an amount of data to be transmitted to the server 410 according to an increase in a danger level.

Referring to FIG. 42, when a situation corresponding to the danger level “fourth grade” occurs, the wearable electronic device 300 may inform the user about an occurrence of a dangerous situation using a vibration or a voice.

Also, the control unit 310 may transmit, to the server 410 through the communicator 350, information, for example, user bio-information, location/motion information, and peripheral situation information, stored in the storage 360 during a predetermined period of time by an occurrence point in time of a dangerous situation.

Referring to FIG. 43, in response to an occurrence of the danger level “fourth grade”, the wearable electronic device 300 may receive user bio-information, location/motion information, and peripheral situation information from the server 410, and may display the received user bio-information, location/motion information, and peripheral situation information on the screen 420.

A danger level “third grade” may indicate a case in which a user location is deviated from a preset safe location during a predetermined period of time and a pulse rate of the user exceeds an upper limit value.

When a situation corresponding to the danger level “third grade” occurs, the wearable electronic device 300 may inform the user about the occurrence of the danger level “third grade” using a vibration or a voice.

Also, the wearable electronic device 300 may transmit, to the server 410, information, for example, user bio-information, location/motion information, and peripheral situation information, stored in the storage 360 during a predetermined period of time by an occurrence point in time of the dangerous situation, together with a synchronized image.

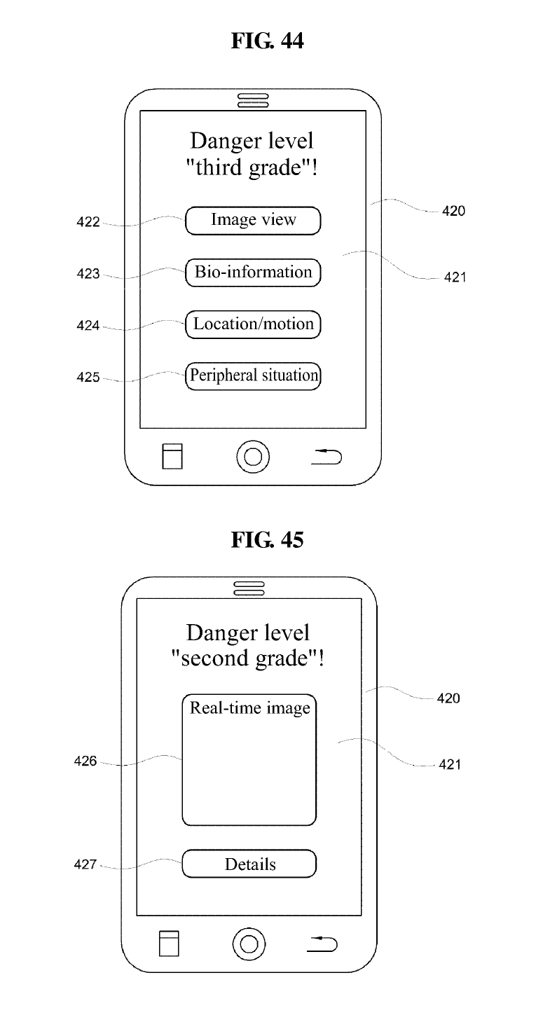

Referring to FIG. 44, in response to an occurrence of the danger level “third grade”, the guardian terminal 420 may receive user bio-information, location/motion information, peripheral situation information, and the image from the server 410, and may display the received user bio-information, location/motion information, peripheral situation information, and image on the screen 420.

Meanwhile, the occurrence of the danger level “third grade” may be continuously alarmed using a vibration or a voice of the guardian terminal 420 until the guardian recognizes the corresponding situation and takes a predetermined action.

A danger level “second grade” may indicate a case in which a user location is deviated from a preset safe location during a predetermined period of time and both a pulse rate and an instantaneous acceleration exceed an upper limit value, or a case in which an ambient sound of the user reaches a danger level.

When a situation corresponding to the danger level “second grade” occurs, the wearable electronic device 300 may inform the user about the occurrence of the danger level “second grade” using a vibration or a voice.

Also, the wearable electronic device 300 may transmit, to the server 410, user bio-information, location/motion information, and peripheral situation information stored in the storage during a predetermined period time by an occurrence point in time of the dangerous situation, together with a synchronized image, and may photograph a peripheral situation in real time and may transmit a real-time image to the server 410.

Referring to FIG. 45, in response to an occurrence of the danger level “second grade”, the guardian terminal 420 may display, on the screen 420, user bio-information, location/motion information, and peripheral situation information received from the server 410, and more importantly, may display, on the screen 420, a real-time image around the wearable electronic device 300 received from the server 410.

Meanwhile, the occurrence of the danger level “second grade” may be continuously alarmed using a vibration or a voice of the guardian terminal 420 until the guardian recognizes a corresponding situation and takes a predetermined action.

A danger level “first grade” may indicate a case in which a pulse rate is less than a lower limit value, which is very small or absent, and may indicate a heart attack, a probability of excessive bleeding, and a compulsory take-off of the wearable electronic device 300 by a criminal.

Referring to FIG. 46, in response to an occurrence of the danger level “first grade”, the guardian terminal 420 may display a real-time image on the screen 420 together with user bio-information, location/motion information, and peripheral situation information received from the server 410, so that the guardian may verify a report of an emergency situation to a police station or a hospital.

Meanwhile, the wearable electronic device 300 may operate all sensors capable of recognizing a current state of a user and a peripheral situation, and may continuously transmit an image and relevant information to the public institution server 430 in real time.

An operation according to a danger level may be adjusted to be suitable for a battery state of the wearable electronic device 300 periodically checked. A photographing and sensing period may be decreased according to an increase in the danger level.

Meanwhile, when the user is determined to be in a safe situation as a result of verifying a state of the user using the guardian terminal 420, the guardian may set a current state of the wearable electronic device 300 as a normal state through a remote control.

In addition to the aforementioned danger level grades, when the user is in a stationary state and a body heat of the user is relatively high, it may be determined that the user is highly likely to be sick and only body heat information may be transmitted to the guardian terminal 420.

According to an embodiment of the present invention, the aforementioned user log record and transmission operation may be performed based on an item of interest preset by the user.

For example, an image and a voice may be set to be automatically recorded when the user visits a predetermined location in a predetermined time zone and a pulse rate or a motion at a predetermined point in time may be set to be recorded in synchronization therewith.

A weight used to determine a danger level may be varied by the user or the guardian of the user.

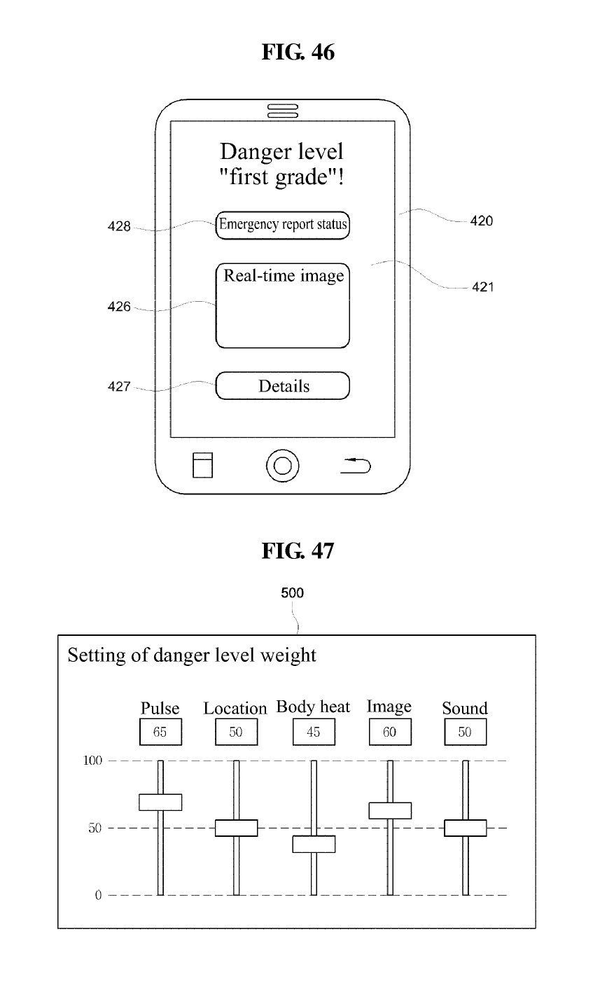

Referring to FIG. 47, the user may set a weigh with respect to each of a pulse rate, a location, a body heat, an image, and a sound using a terminal. For example, the user may set predetermined information as an important item in determining a danger level by increasing a weight of the predetermined information, or may set predetermined information as a relatively unimportant item in determining a danger level by lowering a weigh of the predetermined information.

According to an embodiment of the present invention, an image and user relevant information managed as above may be expressed based on a movement of the user.

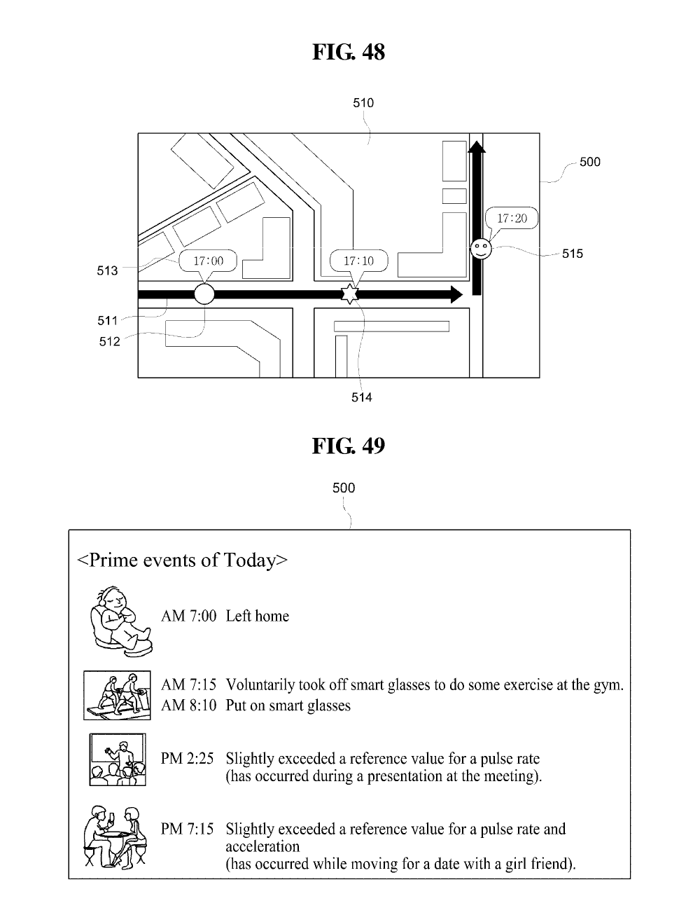

FIG. 48 is a view describing a method of providing a life log of a user together with map information according to an embodiment of the present invention.

Referring to FIG. 48, a map 510 may be displayed on a screen of the terminal 500 and a moving route 511 of the user may be displayed on the map 510. The moving route 511 displayed on the map 510 may be obtained through a GPS device provided to the wearable electronic device 300.

Points 512, 514, and 515 at which an image and user related information are synchronized may be indicated on the moving route 511 of the map 510. Time information 513 corresponding to the respective points 512, 513, and 515 may be indicated to be adjacent thereto.

The user may select one of the points 512, 513, and 515, and may verify an image, bio-information, motion/location information, and peripheral situation information obtained at a corresponding point in time.

Among the points 512, 513, and 515 displayed on the moving route 511 of the map 510, a predetermined point, for example, the point 514 marked with an asterisk may indicate a point at which the user has uploaded a corresponding image and relevant information to an SNS.

Meanwhile, among the points 512, 513, and 515 displayed on the moving route 511 of the map 510, a predetermined point, for example, the point 515 marked with a facial image may indicate a point at which a most recent image and relevant information are obtained.

The methods according to the embodiments of the present invention may be configured as a program to be executed in a computer and may be recorded in non-transitory computer-readable media. Examples of non-transitory computer-readable media may be read only memory (ROM), random access memory (RAM), CD-ROM, magnetic tapes, floppy disks, and optical data storage devices, and may also be configured in a form of carrier waves, for example, transmission over the Internet.

Non-transitory computer-readable media may be distributed to network-coupled computer systems and a code computer-readable using a distributed method may be stored and executed. Function programs, codes, and code segments to achieve the methods may be readily inferred by programmers in the art to which the present invention belongs.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A wearable electronic device provided with at least one lens and a display device configured to display information on the lens, the wearable electronic device comprising:
a sensing unit configured to obtain user bio-information of the wearable electronic device; and
a control unit configured to perform a user authentication based on the obtained user bio-information and to control a function of the wearable electronic device based on a result of the user authentication.

2. A wearable electronic device provided with at least one lens and a display device configured to display information on the lens, the wearable electronic device comprising:
a camera configured to capture an image by performing photographing at predetermined intervals;
a sensing unit configured to detect user bio-information and motion information of the wearable electronic device; and
a control unit configured to synchronize the captured image with information detected by the sensing unit, and to control the synchronized image to be stored or transmitted.
